(19) United States
(12) Patent Application Publication
(10) Pub. No.: US 2003/0148909 A1
(43) Pub. Date: Aug. 7, 2003

(54) Bleaching compositions for dark colored fabric and articles comprising same

(76) Inventors: Valerio Del Duca, Rome (IT); Milena Leone, Brussels (BE); Alberto Scarmagnan, Valdagno (IT); Mark Pieter Andrie Van Der Heijden, Rome (IT); Nabil Yakub Sakkab, Brussels (BE); Toan Trinh, Maineville, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/247,529

(22) Filed: Sep. 19, 2002

Related U.S. Application Data
(60) Provisional application No. 60/323,303, filed on Sep. 19, 2001.

(51) Int. Cl. D06L 1/00; C11D 3/37

(52) U.S. Cl. 510/302; 510/276; 510/499; 510/475

(57) ABSTRACT

The present invention relates to a process of treating fabrics with a liquid bleaching composition comprising at least 3% of a peroxygen bleach and a dye maintenance agent, wherein said process comprises the steps of contacting said fabrics with said liquid composition in its neat or diluted form and washing said fabrics with an aqueous bath comprising water and a conventional laundry detergent, preferably comprising at least one surface active agent, before and/or during and/or after the step of contacting said fabrics with said liquid composition. The present invention also relates to articles of manufacture and methods for safely bleaching and/or removing stain from dark colored fabric. The article comprises a liquid bleach composition comprising peroxygen bleach and dye maintenance agent in a package and a set of instructions associated with the package. The method comprises the steps of providing a liquid bleach composition in a package; and providing a set of instructions associated with the package. The set of instructions includes instructions for safely bleaching and/or removing stain from dark colored fabric through the use of the liquid bleach composition.

### CROSS REFERENCE TO RELATED APPLICATIONS

This application claims priority under 35 U.S.C. §119(e) to U.S. Provisional Application Serial No. 60/323,303, filed Sep. 19, 2001 (Attorney Docket No. CM2608MP).

### TECHNICAL FIELD

The present invention relates to liquid bleaching compositions and in particular to a process of treating fabrics with a liquid bleaching composition comprising a dye maintenance agent.

### BACKGROUND OF THE INVENTION

Bleach-containing compositions for treating fabrics are well known in the art.

Peroxygen bleach-containing compositions have been extensively described in the art, especially in laundry applications as laundry additives and/or laundry pretreaters.

Indeed, it is known to use such peroxygen bleach-containing compositions in laundry applications to boost the removal of dried on (encrusted) stains/soils and “problem” stains, such as grease, coffee, tea, grass, mud/clay-containing soils, which are otherwise particularly difficult to remove. In addition, peroxygen bleaches are considered as being safer to fabrics/carpets, specifically to coloured fabrics/carpets, compared to other bleaches, as for example hypohalite bleaches.

Nevertheless, bleaching compositions have the inconvenience of having a tendency of damaging fabrics treated therewith. Indeed, said compositions may cause color damage (“discoloration”) of dyed fabrics treated with said compositions, in particular dark colored fabrics dyed with sulphated dyes are prone to discoloration.

It is known in the art to formulate bleaching compositions comprising ingredients providing “color-safety benefits” to said bleaching compositions. Such ingredients providing color-safety benefits (“color safety ingredients”) are included into bleaching compositions due to the tendency of peroxygen bleach to form aggressive bleach-species during the decomposition of the peroxygen bleach, upon storage or during use or thereafter. It is well known, that said aggressive bleach-species are responsible for causing damage to colored fabrics. Indeed, color safety ingredients prevent or at least reduce the formation of aggressive bleach-species and hence prevent an attack of the aggressive bleach-species on fabric dyes. For example, WO96/26999 describes a laundry pretreatment composition comprising a chelant, wherein fabric safety and/or color safety benefits are provided to said laundry pretreatment composition.

It is submitted that bleaching compositions comprising color safety ingredients show a good color safety performance. However, the prevention of discoloration of dyed fabrics when treated with liquid bleaching compositions may still be further improved. Indeed, it has been found by consumer research that it is desirable for consumers to have bleaching pretreatment/additive compositions that provide “active color protection”. By “active color protection” it is meant herein the active protection of dyed fabrics against discoloration caused by interaction of a wash solution and the fabric dyes. Indeed, color protection in a bleaching composition may be provided independently of a color safety benefit or even in combination of a color safety benefit coming from color safety ingredients.

It is therefore an objective of the present invention to provide a liquid bleaching composition comprising a peroxygen bleach wherein said composition provides an active color protection benefit to fabrics treated said liquid bleaching composition.

It has now been found that this objective can be met by a process of treating fabrics as described herein.

Advantageously, the bleaching compositions as described herein also provide excellent bleaching performance.

More particularly, the compositions of the present invention provide excellent bleaching performance when used as a laundry additive and/or a laundry pretreater.

A further advantage of the bleaching compositions according to the present invention is that they are able to perform in a variety of conditions, i.e., in hard and soft water as well as when used neat or diluted.

### SUMMARY OF THE INVENTION

The present invention encompasses a process of treating fabrics with a liquid bleaching composition comprising at least about 3% of a peroxygen bleach and a dye maintenance agent, wherein said process comprises the steps of contacting said fabrics with said liquid composition in its neat or diluted form and washing said fabrics with an aqueous bath comprising water and a conventional laundry detergent, preferably comprising at least one surface active agent, before and/or during and/or after the step of contacting said fabrics with said liquid composition.

### DETAILED DESCRIPTION OF THE INVENTION

The Bleaching Composition

The bleaching composition according to the present invention is formulated as a liquid composition. By “liquid” it is meant to include conventional liquids, gels and pastes.

The bleaching compositions herein are preferably, but not necessarily formulated as aqueous compositions. Liquid bleaching compositions are preferred herein for convenience of use. Preferred liquid bleaching compositions of the present invention are aqueous and therefore, preferably may comprise water, more preferably may comprise water in an amount of from about 60% to about 98%, even more preferably of from about 80% to about 97% and most preferably about 85% to about 97% by weight of the total composition.

The pH of the liquid bleaching compositions herein, as is measured at 25° C., preferably is at least, with increasing preference in the order given, about 0.1, about 0.5, about 1, about 1.5, about 2, about 2.5, about 3, about 3.5, about 4, about 4.5 or about 5. Independently, the pH of the liquid bleaching compositions herein, as is measured at 25° C., preferably is no more than, with increasing preference in the order given, about 9, about 8.5, about 8, about 7.5, about 7, about 6.5, about 6 or about 5.5.

In a preferred embodiment the liquid compositions according to the present invention are formulated in the neutral to the acidic pH range. It is within this neutral to acidic pH range that the optimum chemical stability and bleaching and/or cleaning performance of the peroxygen bleach as well as optimum fabric- and/or color-safety are obtained.

Accordingly, the compositions herein may further comprise an acid or a base to adjust the pH as appropriate.

Preferred acids herein are organic or inorganic acids or mixtures thereof. Preferred organic acids are acetic acid, citric acid or a mixture thereof. Preferred inorganic acids are sulfuric acid, phosphoric acid or a mixture thereof. A particularly preferred acid to be used herein is an inorganic acid and most preferred is sulfuric acid.

Typical levels of such acids, when present, are of from about 0.01% to about 3.0%, preferably from about 0.05% to about 2.0% and more preferably from about 0.1% to about 1.0% by weight of the total composition.

The bases to be used herein can be organic or inorganic bases. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate and hydrogen carbonate.

Typical levels of such bases, when present, are of from about 0.01% to about 1.0%, preferably from about 0.05% to about 0.8% and more preferably from about 0.1% to about 0.5% by weight of the total composition.

Peroxygen Bleach

As a first essential element the bleaching compositions according to the present invention comprise a peroxygen bleach.

Suitable peroxygen bleaches to be used herein are selected from the group consisting of: hydrogen peroxide; water soluble sources of hydrogen peroxide; organic or inorganic peracids; hydroperoxides; diacyl peroxides; and mixtures thereof.

As used herein a hydrogen peroxide source refers to any compound that produces perhydroxyl ions on contact with water. Suitable water-soluble sources of hydrogen peroxide for use herein include percarbonates, perborates and persilicates and mixtures thereof.

Suitable diacyl peroxides for use herein include aliphatic, aromatic and aliphatic-aromatic diacyl peroxides, and mixtures thereof.

Suitable aliphatic diacyl peroxides for use herein are dilauroyl peroxide, didecanoyl peroxide, dimyristoyl peroxide, or mixtures thereof. A suitable aromatic diacyl peroxide for use herein is for example benzoyl peroxide. A suitable aliphatic-aromatic diacyl peroxide for use herein is for example lauroyl benzoyl peroxide.

Suitable organic or inorganic peracids for use herein include: persulphates such as monopersulfate; peroxyacids such as diperoxydodecandioic acid (DPDA); magnesium perphthalic acid; perlauric acid; phthaloyl amidoperoxy caproic acid (PAP); perbenzoic and alkylperbenzoic acids; and mixtures thereof.

Suitable hydroperoxides for use herein are tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide and mixtures thereof. Such hydroperoxides have the advantage of being particularly safe to fabrics and color while delivering excellent bleaching performance when used in any laundry application. Furthermore, such hydroperoxides have the advantage of being particularly safe to carpets and carpet dyes whilst delivering excellent bleaching performance when used in carpet treatment applications.

A preferred peroxygen bleach herein is selected from the group consisting of: hydrogen peroxide; water-soluble sources of hydrogen peroxide; organic or inorganic peracids; hydroperoxides; and diacyl peroxides; and mixtures thereof. A more preferred peroxygen bleach herein is selected from the group consisting of hydrogen peroxide, water-soluble sources of hydrogen peroxide and diacyl peroxides and mixtures thereof. An even more preferred peroxygen bleach herein is selected from the group consisting of hydrogen peroxide, water soluble sources of hydrogen peroxide, aliphatic diacyl peroxides, aromatic diacyl peroxides and aliphatic-aromatic diacyl peroxides and mixtures thereof. The most preferred peroxygen bleach herein is hydrogen peroxide, water-soluble sources of hydrogen peroxide or mixtures thereof.

The liquid compositions according to the present invention comprise at least 3% by weight of the total composition of said peroxygen bleach. Preferably, the bleaching composition herein may comprise from about 3% to about 30%, preferably from about 4% to about 20%, more preferably from about 4.5% to about 15%, even more preferably from about 5% to about 10%, and most preferably from about 5.5% to about 10% by weight of the total composition of said peroxygen bleach.

The presence of a peroxygen bleach in bleaching compositions according to the present invention contributes to the excellent bleaching and/or cleaning performance on various types of soils including on spot stains like bleachable stains (e.g., coffee, beverage, food) of the compositions of the present invention. Furthermore, peroxygen bleaches are chosen herein as oxidising agents over other oxidising agents, as for example hypohalite bleaches, as they are considered as being safer to fabrics, specifically to coloured fabrics.

By “bleachable stains” it is meant herein any soils or stains containing ingredients sensitive to bleach that can be found on any carpet, e.g., coffee or tea.

Dye Maintenance Agent

As a second essential ingredient the compositions according to the present invention comprise a dye maintenance agent.

Any dye maintenance agent known to those skilled in the art are suitable for use herein.

Suitable dye maintenance agent are described as cyclic amine based polymers, oligomers or copolymers in WO 99/14301 and dye maintenance polymers or oligomers in WO 00/56849, both documents being incorporated herein by reference.

Typically, the bleaching compositions according to the present invention may comprise from about 0.001% to about 30%, preferably from about 0.01% to about 15% and more preferably from about 0.05% to about 5% by weight of the total composition of a dye maintenance agent.

In a preferred embodiment the dye maintenance agent is a cyclic amine based polymer, oligomer or copolymer.

Preferably, said cyclic amine based polymers, oligomers or copolymers are of the general formula:

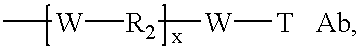

wherein each T is independently selected from the group consisting of: H, C₁-C₁₂ alkyl, substituted alkyl, C₇-C₁₂ alkylaryl,

—(CH₂)ₕCOOM, —(CH₂)ₕSO₃M, CH₂CH(OH)SO₃M, —(CH₂)ₕOSO₃M,

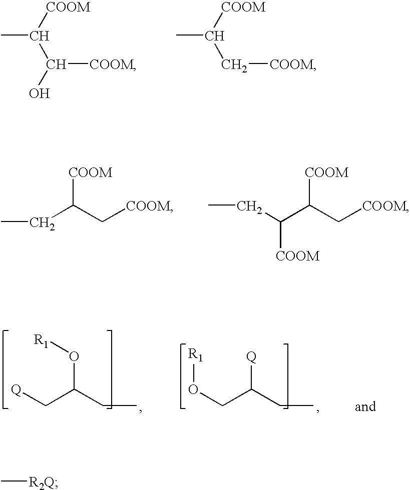

wherein W comprises at least one cyclic constituent selected from the group consisting of:

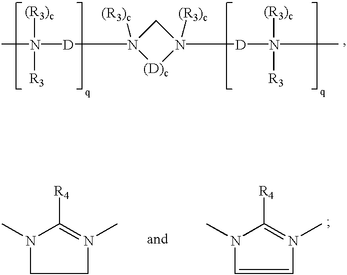

in addition to the at least one cyclic constituent, W may also comprise an aliphatic or substituted aliphatic moiety of the general structure;

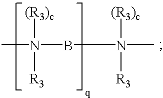

each B is independently C₁-C₁₂ alkylene, C₁-C₁₂ substituted alkylene, C₃-C₁₂ alkenylene, C₈-C₁₂ dialkylarylene, C₈-C₁₂ dialkylarylenediyl, and —(R₅O)ₙR₅—;

each D is independently C₂-C₆ alkylene;

each Q is independently selected from the group consisting of hydroxy, C₁-C₁₈ alkoxy, C₂-C₁₈ hydroxy alkoxy, amino, C₁-C₁₈ alkyl amino, dialkyl amino, trialkyl amino groups, heterocyclic monoamino groups and diamine groups;

each R₁ is independently selected from the group consisting of H, C₁-C₈ alkyl and C₁-C₈ hydroxyalkyl;

each R₂ is independently selected from the group consisting of C₁-C₁₂ alkylene, C₁-C₁₂ alkenylene, —CH₂—CH(OR₁)—CH₂, C₈-C₁₂ alkarylene, C₄-C₁₂ dihydroxy alkylene, poly(C₂-C₄ alkyleneoxy)alkylene, H₂CH(OH)CH₂OR₂OCH₂CH(OH)CH₂—, and C₃-C₁₂ hydrocarbyl moieties;

provided that when R₂ is a C₃-C₁₂ hydrocarbyl moiety the hydrocarbyl moiety can comprise from 2 to 4 branching moieties of the general structure:

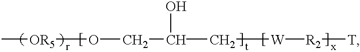

each R₃ is independently selected from the group consisting of H, R₂, O, C₁-C₂₀ hydroxyalkyl, C₁-C₂₀ alkyl, substituted alkyl, C₆-C₁₁ aryl, substituted aryl, C₇-C₁₁ alkylaryl, C₁-C₂₀ aminoalkyl,

—(CH₂)ₕCOOM, —(CH₂)ₕSO₃M, CH₂CH(OH)SO₃M, —(CH₂)ₕOSO₃M,

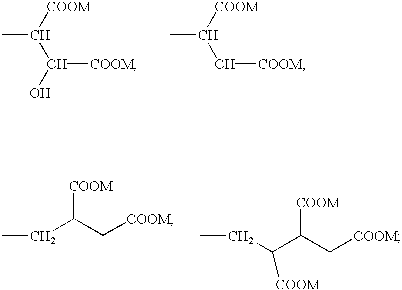

wherein at least about about 10 mole %, preferably at least about about 20 mole %, more preferably at least about about 30 mole %, and most preferably at least about about 50 mole % of the R₃ groups are O, provided that O is only present on a tertiary N;

each R₄ is independently selected from the group consisting of H, C₁-C₂₂ alkyl, C₁-C₂₂ hydroxyalkyl, aryl and C₇-C₂₂ alkylaryl;

each R₅ is independently selected from the group consisting of C₂-C₈ alkylene, C₂-C₈ alkyl substituted alkylene; and

A is a compatible monovalent or di or polyvalent anion;

M is a compatible cation;

and wherein b=number necessary to balance the charge; each x is independently from about 3 to about 1000; each c is independently 0 or 1; each h is independently from 1 to about 8; each q is independently from 0 to about 6; each n is independently from 1 to about 20; each r is independently from 0 to about 20; and each t is independently from 0 to about 1.

More preferably, said cyclic amine based polymers, oligomers or copolymers are of the above formula, wherein each R₁ is H and at least one W is selected from the group consisting of:

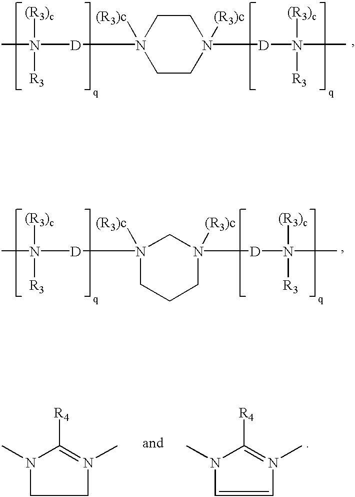

Even more preferably, said cyclic amine based polymers, oligomers or copolymers are of the above formula, wherein R₁ is H and at least one W is selected from the group consisting of:

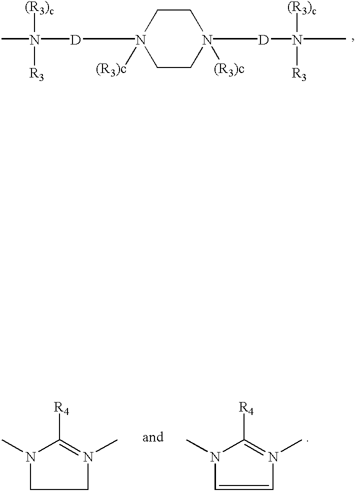

Still more preferably, said cyclic amine based polymers, oligomers or copolymers are of the above formula, wherein each R₁ is H and at least one W is selected from the group consisting of:

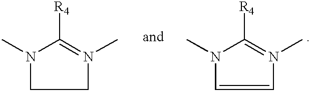

In a preferred embodiment according to the present invention, said cyclic amine based polymers, oligomers or copolymers are oxidized adducts selected from the group consisting of piperazine, piperidine, epichlorohydrin, epichlorohydrin benzyl quat, epichlorohydrin methyl quat, morpholine and mixtures thereof.

In another preferred embodiment according to the present invention, the dye maintenance agent herein is imidazole: epi-chlorohydrin copolymer (condensation oligomer of imidazole and epi-chlorohydrin at a ratio of about 1:4:1).

A suitable imidazole: epi-chlorohydrin copolymer dye maintenance agent is commercially available under the trade name Sokalan PG-IME® from BASF.

It has been found that peroxygen bleach-containing bleaching compositions have the inconvenience of having a tendency of causing color damage (“discoloration”) of dyed fabrics treated with said compositions, in particular dark colored fabrics dyed with sulphated dyes are prone to discoloration. Indeed, it lies in the nature of peroxygen bleach to discolor dyed fabrics, which is an unwanted side effect of the bleaching activity of the peroxygen bleach.

It has now been found that dye maintenance agents in bleaching compositions provide an active color protection benefit.

By “active color protection” it is meant herein the active protection of dyed fabrics against discoloration caused by interaction of a wash solution and the fabric dyes (“color protection benefit”). Indeed, color protection in a bleaching composition may be provided independently of a color safety benefit or even in combination of a color safety benefit coming from color safety ingredients.

Indeed, it has been observed that dye maintenance agents specifically adhere to dye molecules deposited on fabrics, preferably sulphate groups of dye molecules, and thereby reduce the solubility of said dye molecules. Thereby, protecting said dyes from solubilising them off the fabric and thereby discoloring said fabric caused by the interaction of the bleaching composition and/or the wash solution formed by a conventional laundry detergent used in addition to the bleaching composition and the dye.

Test Method for Color Protection

The color protection can be assessed by visual grading. The following test protocol may be applied to asses the color protection benefit as provided herein of a giving bleaching composition: about 100 ml of said given bleaching composition are added into a standard washing machine in combination with about 135 g of a conventional laundry detergent (e.g., DASH Essential® or DASH liquid®). A colored fabric (e.g., a fabric dyed with direct violet C111) is treated in said washing machine according to the standard procedure of the washing machine. This treatment can be repeated for 5 or 10 times.

The visual grading may be performed by a group of expert panelists using panel score units (PSU). To asses the fabric color protection benefit of a given bleaching composition a PSU-scale ranging from 0, meaning no noticeable difference in discoloration of a treated fabric versus an untreated fabric, to 4, meaning a clearly noticeable difference in discoloration of a treated fabric versus an untreated fabric, can be applied.

Process of Treating Fabrics

In the present invention, the bleaching composition of the present invention is used by contacting fabrics with a liquid bleaching composition. By “in a liquid form” it is meant herein, the liquid compositions according to the present invention per se in neat or diluted form.

The compositions according to the present invention are typically used in diluted form in a laundry operation. By “in diluted form” it is meant herein that the compositions for the bleaching of fabrics according to the present invention may be diluted by the user, preferably with water. Such dilution may occur for instance in soaking applications as well as by other means such as in a washing machine. Said compositions may be used at a dilution level of up to about 1500:1 (solvent:composition), preferably from about 5:1 to about 1000:1 and more preferably from about 10:1 to about 700:1 (solvent:composition).

By “in its neat form”, it is to be understood that the liquid bleaching compositions are applied directly onto the fabrics to be treated without undergoing any dilution, i.e., the liquid compositions herein are applied onto the fabrics as described herein.

Fabrics to be treated herein include, but are not limited to, clothes, curtains, drapes, bed linens, bath linens, tablecloths, sleeping bags and/or tents.

By “treating a fabric”, it is meant herein cleaning said and/or bleaching/disinfecting said fabric.

In the process of treating (e.g., cleaning and/or bleaching) a fabric, a bleaching composition according to the present invention is contacted with the fabrics to be treated.

This can be done either in a so-called “pretreatment mode”, where a liquid bleaching composition, as defined herein, is applied neat onto said fabrics before the fabrics are washed or in a “soaking mode” where a liquid bleaching composition, as defined herein, is first diluted in an aqueous bath and the fabrics are immersed and soaked in the bath, before they are washed, or in a “through-the-wash mode”, where a liquid bleaching composition, as defined herein, is added in addition to a wash liquor formed by dissolution or dispersion of a conventional laundry detergent, preferably in a washing machine.

More specifically, the pretreatment process of bleaching fabrics according to the present invention preferably comprises the steps of first contacting said fabrics with a bleaching composition according to the present invention, then allowing said fabrics to remain in contact with said composition, for a period of time sufficient to bleach said fabrics, then rinsing said fabrics with water before being washed.

The bleaching composition may be used in dilute or neat form. Where it is used diluted, the bleaching composition should remain in contact with the fabric for typically about 1 to about 60 minutes, preferably about 5 to about 30 minutes. Whereas, when the bleaching composition is used in its neat form, it should remain in contact with the fabric for a much shorter time, typically about 5 seconds to about 30 minutes, preferably about 1 minute to about 10 minutes.

In the process herein, said fabrics are to be washed, i.e., treated with a conventional laundry detergent, preferably comprising at least one surface active agent, the washing of said fabrics with a conventional laundry detergent may be conducted before the step of contacting said fabrics with said bleaching composition and/or during the step of contacting fabrics are contacted with said bleaching composition and/or after the step where said fabrics are contacted with the bleaching composition.

In a preferred embodiment, the washing of said fabrics with a conventional laundry detergent is conducted before the step of contacting said fabrics with said bleaching composition and/or during the step of contacting fabrics are contacted with said bleaching composition. More preferably, he washing of said fabrics with a conventional laundry detergent is conducted before the step of contacting said fabrics with said bleaching composition. Indeed, it has been observed that bleaching said fabrics with the compositions according to the present invention (diluted and/or neat bleaching processes) prior to washing them with a detergent composition provides superior whiteness and stain removal with less energy and detergent than if said fabrics are washed first, then bleached.

In a preferred embodiment according to the present invention, the conventional laundry detergent as described herein are dissolved or dispersed, preferably substantially dissolved or dispersed, in the aqueous bath formed in the process according to the present invention. By “substantially dissolved or dispersed” it is meant herein, that at least about 50%, preferably at least about 80%, more preferably at least about 90%, even more preferably at least about 95%, still more preferably at least about 98%, and most preferably at least about 99%, of said conventional laundry detergent are dissolved or dispersed in the aqueous bath formed in the process according to the present invention.

In a preferred embodiment, the washing step according to the present invention is performed in a washing machine. The conventional detergent composition may be delivered into the washing machine either by charging the dispenser drawer of the washing machine with the detergent or by directly charging the drum of the washing machine with the detergent.

By “conventional laundry detergent” it is meant herein, a laundry detergent composition currently available on the market. Preferably, said conventional laundry detergent comprises at least one surface active agent (“surfactant” as described herein below). Said laundry detergent compositions may be formulated as powders, liquids or tablets. Suitable laundry detergent compositions are for example DASH futur®, DASH essential®, DASH liquid®, ARIEL tablets® and other products sold under the trade names ARIEL® or TIDE®.

A further advantage of process herein is the cleaning performance. In fact, the cleaning performance benefits of the combination of both the liquid bleaching composition and the conventional laundry detergent is greater than the performance provided by either composition alone.

Optional Ingredients

The bleaching compositions herein may further comprise a variety of optional ingredients such as surfactants, thickeners, builders, chelating agents, stabilisers, bleach activators, soil suspenders, soil suspending polyamine polymers, polymeric soil release agents, foam reducing systems or agents, catalysts, dye transfer agents, brighteners, perfumes, hydrotropes, solvents, pigments and dyes.

Surfactants

The compositions according to the present invention may comprise as a highly preferred but optional ingredient a surfactant.

Typically, the compositions according to the present invention may comprise from about 0.01% to about 30%, preferably from about 0.1% to about 25% and more preferably from about 0.5% to about 20% by weight of the total composition of a surfactant.

Suitable nonionic surfactants include alkoxylated nonionic surfactants. Preferred alkoxylated nonionic surfactants herein are ethoxylated nonionic surfactants according to the formula RO—(C₂H₄O)ₙH, wherein R is a C₆ to C₂₂ alkyl chain or a C₆ to C₂₈ alkyl benzene chain, and wherein n is from 0 to about 20, preferably from about 1 to about 15 and, more preferably from about 2 to about 15 and most preferably from about 2 to about 12. The preferred R chains for use herein are the C₈ to C₂₂ alkyl chains. Propoxylated nonionic surfactants and ethoxy/propoxylated ones may also be used herein instead of the ethoxylated nonionic surfactants as defined herein above or together with said surfactants

Preferred ethoxylated nonionic surfactants are substantially linear ethoxylated nonionic surfactants according to the above formula. By “linear” it is meant herein that the fatty alcohols used as a basis of the nonionic surfactant (raw material) at least about 90%, preferably at least about 95%, more preferably at least about 97%, and most preferably 100% by weight of the total amount of fatty alcohols of linear (i.e., straight chain) fatty alcohols.

Suitable substantially linear ethoxylated nonionic surfactants for use herein are Marlipal® 24-7 (R is a mixture of linear C₁₂ and C₁₄ alkyl chains, n is 7), Marlipal® 24-4 (R is a mixture of linear C₁₂ and C₁₄ alkyl chains, n is 4), Marlipal® 24-3 (R is a mixture of linear C₁₂ and C₁₄ alkyl chains, n is 3), Marlipal® 24-2 (R is a mixture of linear C₁₂ and C₁₄ alkyl chains, n is 2), or mixtures thereof. Preferred herein are Marlipal® 24-7, Marlipal® 24-4, or mixtures thereof. These Marlipal® surfactants are commercially available from Condea.

Preferred ethoxylated nonionic surfactants are according to the formula above and have an HLB (hydrophilic-lipophilic balance) below about 16, preferably below about 15, and more preferably below about 14. Those ethoxylated nonionic surfactants have been found to provide good grease cutting properties.

Accordingly suitable ethoxylated nonionic surfactants for use herein are, for instance, Dobanol® 91-2.5 (HLB=8.1; R is a mixture of C9 and C₁₁ alkyl chains, n is 2.5), or Lutensol® TO3 (HLB=8; R is a C₁₃ alkyl chains, n is 3), or Lutensol® AO3 (HLB=8; R is a mixture of C₁₃ and C₁₅ alkyl chains, n is 3), or Tergitol® 25L3 (HLB=7.7; R is in the range of C₁₂ to C₁₅ alkyl chain length, n is 3), or Dobanol® 23-3 (HLB=8.1; R is a mixture of C₁₂ and C₁₃ alkyl chains, n is 3), or Dobanol® 23-2 (HLB=6.2; R is a mixture of C₁₂ and C₁₃ alkyl chains, n is 2), or Dobanol® 45-7 (HLB=11.6; R is a mixture of C₁₄ and C₁₅ alkyl chains, n is 7). Preferred herein are Dobanol® 91-2.5, or Lutensol® TO3, or Lutensol® AO3, or Tergitol® 25L3, or Dobanol® 23-3, or Dobanol® 23-2, or Dobanol® 45-7, Dobanol® 91-8, Dobanol® 91-10, or Dobanol® 91-12, or mixtures thereof. These Dobanol® surfactants are commercially available from SHELL. These Lutensol® surfactants are commercially available from BASF and these Tergitol® surfactants are commercially available from UNION CARBIDE.

Suitable chemical processes for preparing the alkoxylated nonionic surfactants for use herein include condensation of corresponding alcohols with alkylene oxide, in the desired proportions. Such processes are well known to the man skilled in the art and have been extensively described in the art.

Other suitable nonionic surfactants to be used herein include polyhydroxy fatty acid amide surfactants, or mixtures thereof, according to the formula:

R²—C(O)—N(R¹)—Z,

wherein R¹ is H, or C₁₋C₄ alkyl, C₁₋C₄ hydrocarbyl, 2-hydroxy ethyl, 2-hydroxy propyl or a mixture thereof, R² is C₅₋C₃₁ hydrocarbyl, and Z is a polyhydroxyhydrocarbyl having a linear hydrocarbyl chain with at least 3 hydroxyls directly connected to the chain, or an alkoxylated derivative thereof.

Preferably, R¹ is C₁₋C₄ alkyl, more preferably C₁ or C₂ alkyl and most preferably methyl, R² is a straight chain C₇₋C₁₉ alkyl or alkenyl, preferably a straight chain C₉₋C₁₈ alkyl or alkenyl, more preferably a straight chain C₁₁₋C₁₈ alkyl or alkenyl, and most preferably a straight chain C₁₁₋C₁₄ alkyl or alkenyl, or mixtures thereof. Z preferably will be derived from a reducing sugar in a reductive amination reaction; more preferably Z is a glycityl. Suitable reducing sugars include glucose, fructose, maltose, lactose, galactose, mannose and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂—(CHOR′)(CHOH)—CH₂OH, where n is an interger from 3 to 5, inclusive, and R′ is H or a cyclic or aliphatic monosaccharide, and alkoxylated derivatives thereof. Most preferred are glycityls wherein n is 4, particularly CH₂—(CHOH)₄—CH₂OH.

In formula R²—C(O)—N(R¹)—Z, R¹ can be, for example, N-methyl, N-ethyl, N-propyl, N-isopropyl, N-butyl, N-2-hydroxy ethyl, or N-2-hydroxy propyl. R²—C(O)—N< can be, for example, cocamide, stearamide, oleamide, lauramide, myristamide, capricamide, palmitamide, tallowamide and the like. Z can be 1-deoxyglucityl, 2-deoxyfructityl, 1-deoxymaltityl, 1-deoxylactityl, 1-deoxygalactityl, 1-deoxymannityl, 1-deoxymaltotriotityl and the like.

Suitable polyhydroxy fatty acid amide surfactants to be used herein may be commercially available under the trade name HOE® from Hoechst.

Methods for making polyhydroxy fatty acid amide surfactants are known in the art. In general, they can be made by reacting an alkyl amine with a reducing sugar in a reductive amination reaction to form a corresponding N-alkyl polyhydroxyamine, and then reacting the N-alkyl polyhydroxyamine with a fatty aliphatic ester or triglyceride in a condensation/amidation step to form the N-alkyl, N-polyhydroxy fatty acid amide product. Processes for making compositions containing polyhydroxy fatty acid amides are disclosed for example in GB patent specification 809,060, published Feb. 18, 1959, by Thomas Hedley & Co., Ltd., U.S. Pat. No. 2,965,576, issued Dec. 20, 1960 to E. R. Wilson, U.S. Pat. No. 2,703,798, Anthony M. Schwartz, issued Mar. 8, 1955, U.S. Pat. No. 1,985,424, issued Dec. 25, 1934 to Piggott and WO92/06070, each of which is incorporated herein by reference.

Suitable zwitterionic betaine surfactants for use herein contain both a cationic hydrophilic group, i.e., a quaternary ammonium group, and anionic hydrophilic group on the same molecule at a relatively wide range of pH's. The typical anionic hydrophilic groups are carboxylates and sulphonates, although other groups like sulfates, phosphonates, and the like can be used. A generic formula for the zwitterionic betaine surfactant to be used herein is:

R₁—N⁺(R₂)(R₃)R₄X⁻

wherein R₁ is a hydrophobic group; R₂ is hydrogen, C₁-C₆ alkyl, hydroxy alkyl or other substituted C₁-C₆ alkyl group; R₃ is C₁-C₆ alkyl, hydroxy alkyl or other substituted C₁-C₆ alkyl group which can also be joined to R₂ to form ring structures with the N, or a C₁-C₆ sulphonate group; R₄ is a moiety joining the cationic nitrogen atom to the hydrophilic group and is typically an alkylene, hydroxy alkylene, or polyalkoxy group containing from 1 to 10 carbon atoms; and X is the hydrophilic group, which is a carboxylate or sulphonate group.

Preferred hydrophobic groups R₁ are aliphatic or aromatic, saturated or unsaturated, substituted or unsubstituted hydrocarbon chains that can contain linking groups such as amido groups, ester groups. More preferred R₁ is an alkyl group containing from 1 to 24 carbon atoms, preferably from 8 to 18, and more preferably from 10 to 16. These simple alkyl groups are preferred for cost and stability reasons. However, the hydrophobic group R₁ can also be an amido radical of the formula Rₐ—C(O)—NH—(C(R_{b})₂)ₘ, wherein Rₐ is an aliphatic or aromatic, saturated or unsaturated, substituted or unsubstituted hydrocarbon chain, preferably an alkyl group containing from 8 up to 20 carbon atoms, preferably up to 18, more preferably up to 16, R_{b} is selected from the group consisting of hydrogen and hydroxy groups, and m is from 1 to 4, preferably from 2 to 3, more preferably 3, with no more than one hydroxy group in any (C(R_{b})₂) moiety.

Preferred R₂ is hydrogen, or a C₁-C₃ alkyl and more preferably methyl. Preferred R₃ is C₁-C₄ sulphonate group, or a C₁-C₃ alkyl and more preferably methyl. Preferred R₄ is (CH₂)ₙ wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082, incorporated herein by reference.

Examples of particularly suitable alkyldimethyl betaines include coconut-dimethyl betaine, lauryl dimethyl betaine, decyl dimethyl betaine, 2-(N-decyl-N,N-dimethyl-ammonia) acetate, 2-(N-coco N,N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C₁₀-C₁₄ fatty acylamidopropylene (hydropropylene)sulfobetaine. For example C₁₀-C₁₄ fatty acylamidopropylene (hydropropylene) sulfobetaine is commercially available from Sherex Company under the trade name “Varion CAS® sulfobetaine”.

A further example of betaine is Lauryl-immino-dipropionate commercially available from Rhone-Poulenc under the trade name Mirataine H₂C-HA®.

Suitable anionic surfactants to be used in the compositions herein include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below 50° C.) and C₁₆₋₁₈ alkyl chains are preferred for higher wash temperatures (e.g., above 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)SM), C₁₂-C₁₈ alkyl polyethoxylate (2.25) sulfate (C₁₂-C₁₈E(2.25)SM), C₁₂-C₁₈ alkyl polyethoxylate (3.0) sulfate (C₁₂-C₁₈E(3.0)SM), and C₁₂-C₁₈ alkyl polyethoxylate (4.0) sulfate (C₁₂-C₁₈E(4.0)SM), wherein M is conveniently selected from sodium and potassium.

Other suitable anionic surfactants for use herein are sulphonated anionic surfactants Suitable sulphonated anionic surfactants for use herein include alkyl sulphonates, alkyl aryl sulphonates, naphthalene sulphonates, alkyl alkoxylated sulphonates, C₆-C₂₀ alkyl alkoxylated linear or branched diphenyl oxide disulphonates, or mixtures thereof.

Suitable alkyl sulphonates for use herein include water-soluble salts or acids of the formula RSO₃M wherein R is a C₆-C₂₀ linear or branched, saturated or unsaturated alkyl group, preferably a C₈-C₁₈ alkyl group and more preferably a C₁₄-C₁₇ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₀ linear or branched saturated or unsaturated alkyl group, preferably a C₈-C₁₈ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₄-C₁₇ paraffin sulphonate like Hostapur® SAS commercially available from Hoechst. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright&Wilson.

By “linear alkyl sulphonate” it is meant herein a non-substituted alkyl sulphonate wherein the alkyl chain comprises from 6 to 20 carbon atoms, preferably from 8 to 18 carbon atoms, and more preferably from 14 to 17 carbon atoms, and wherein this alkyl chain is sulphonated at one terminus.

Suitable alkoxylated sulphonate surfactants for use herein are according to the formula R(A)ₘSO₃M wherein R is an unsubstituted C₆-C₂₀ alkyl, hydroxyalkyl or alkyl aryl group, having a linear or branched C₆-C₂₀ alkyl component, preferably a C₁₂-C₂₀ alkyl or hydroxyalkyl, more preferably C₁₂-C₁₈ alkyl or hydroxyalkyl, A is an ethoxy or propoxy or butoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulphonate (C₁₂-C₁₈E(1.0) SO₃M), C₁₂-C₁₈ alkyl polyethoxylate (2.25) sulphonate (C₁₂-C₁₈E(2.25) SO₃M), C₁₂-C₁₈ alkyl polyethoxylate (3.0) sulphonate (C₁₂-C₁₈E(3.0) SO₃M), and C₁₂-C₁₈ alkyl polyethoxylate (4.0) sulphonate (C₁₂-C₁₈E(4.0) SO₃M), wherein M is conveniently selected from sodium and potassium. Particularly suitable alkoxylated sulphonates include alkyl aryl polyether sulphonate like Triton X-200® commercially available from Union Carbide.

Suitable C₆-C₂₀ alkyl alkoxylated linear or branched diphenyl oxide disulphonate surfactants for use herein are according to the following formula:

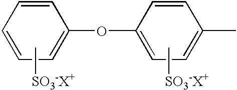

wherein R is a C₆-C₂₀ linear or branched, saturated or unsaturated alkyl group, preferably a C₁₂-C₁₈ alkyl group and more preferably a C₁₄-C₁₆ alkyl group, and X+ is H or a cation, e.g., an alkali metal cation (e.g., sodium, potassium, lithium, calcium, magnesium and the like). Particularly suitable C₆-C₂₀ alkyl alkoxylated linear or branched diphenyl oxide disulphonate surfactants to be used herein are the C₁₂ branched di phenyl oxide disulphonic acid and C₁₆ linear di phenyl oxide disulphonate sodium salt respectively commercially available by DOW under the trade name Dowfax 2A1® and Dowfax 8390®.

Other anionic surfactants suitable herein include sulfosuccinate surfactants, alkyl carboxylate surfactants, sulfosuccinamate surfactants and sulfosuccinamide surfactants.

Suitable alkyl carboxylate surfactants for use herein are according to the formula RCO₂M wherein: R represents a hydrocarbon group selected from the group consisting of straight or branched alkyl radicals containing from 6 to 20, preferably 8 to 18, more preferably 10 to 16, carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Other anionic surfactants useful for detersive purposes can also be used herein. These can include salts (including, for example, sodium, potassium, ammonium, and substituted ammonium salts such as mono-, di- and triethanolamine salts) of soap, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to about 10 moles of ethylene oxide); alkyl ester sulphonates such as C₁₄₋₁₆ methyl ester sulphonates; acyl glycerol sulphonates, fatty oleyl glycerol sulfates, alkyl phenol ethylene oxide ether sulfates, alkyl phosphates, isethionates such as the acyl isethionates, N-acyl taurates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO—M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23 (herein incorporated by reference).

Other suitable anionic surfactants to be used herein also include acyl sarcosinate, in its acid and/or salt form. Being derivatives of natural fatty acids, said acyl sarcosinates are rapidly and completely biodegradable and have good skin compatibility.

Accordingly, suitable long chain acyl sarcosinates to be used herein include C₁₂ acyl sarcosinate (i.e., an acyl sarcosinate according to the above formula wherein M is hydrogen and R is an alkyl group of 11 carbon atoms) and C₁₄ acyl sarcosinate (i.e., an acyl sarcosinate according to the above formula wherein M is hydrogen and R is an alkyl group of 13 carbon atoms). C₁₂ acyl sarcosinate is commercially available, for example, as Hamposyl L-30® supplied by Hampshire. C₁₄ acyl sarcosinate is commercially available, for example, as Hamposyl M-30® supplied by Hampshire.

Suitable amphoteric surfactants to be used herein include amine oxides having the following formula R₁R₂R₃NO wherein each of R₁, R₂ and R₃ is independently a saturated substituted or unsubstituted, linear or branched hydrocarbon chains of from 1 to 30 carbon atoms. Preferred amine oxide surfactants to be used according to the present invention are amine oxides having the following formula R₁R₂R₃NO wherein R₁ is an hydrocarbon chain comprising from 1 to 30 carbon atoms, preferably from 6 to 20, more preferably from 8 to 16, most preferably from 8 to 12, and wherein R₂ and R₃ are independently substituted or unsubstituted, linear or branched hydrocarbon chains comprising from 1 to 4 carbon atoms, preferably from 1 to 3 carbon atoms, and more preferably are methyl groups. R1 may be a saturated substituted or unsubstituted linear or branched hydrocarbon chain. Suitable amine oxides for use herein are for instance natural blend C₈-C₁₀ amine oxides as well as C₁₂-C₁₆ amine oxides commercially available from Hoechst.

Anti-resoiling Polymers

The compositions according to the present invention may comprise as a highly preferred, but optional ingredient an anti-resoiling polymer.

Suitable anti-resoiling polymers include soil suspending polyamine polymers. Any soil suspending polyamine polymer known to those skilled in the art may also be used herein. Particularly suitable polyamine polymers for use herein are alkoxylated polyamines. Such materials can conveniently be represented as molecules of the empirical structures with repeating units:

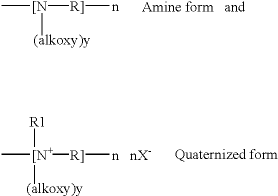

wherein R is a hydrocarbyl group, usually of 2-6 carbon atoms; R₁ may be a C₁-C₂₀ hydrocarbon; the alkoxy groups are ethoxy, propoxy, and the like, and y is from about 2 to about 30, most preferably from about 7 to about 20; n is an integer of at least 2, preferably from 2 to 40, most preferably from 2 to 5; and X− is an anion such as halide or methylsulfate, resulting from the quaternization reaction.

Highly preferred polyamines for use herein are the so-called ethoxylated polyethylene amines, i.e., the polymerized reaction product of ethylene oxide with ethyleneimine, having the general formula:

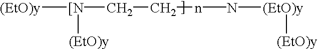

wherein y is from about 2 to about 50, preferably from about 5 to about 30, and n is from 1 to 40, preferably from 2 to 40. Particularly preferred for use herein is an ethoxylated polyethylene amine, in particular an ethoxylated polyethylene amine wherein n=2 and y=20, and an ethoxylated polyethylene amine wherein n=40 and y=7.

Suitable ethoxylated polyethylene amines are commercially available from Nippon Shokubai CO., LTD under the product names ESP-0620A® (ethoxylated polyethylene amine wherein n=2 and y=20) or from BASF under the product names ES-8165 and from BASF under the product name LUTENSIT K-187/50® (ethoxylated polyethylene amine wherein n=40 and y=7).

Furthermore, highly preferred polyamines for use herein are the so-called ethoxylated polyethylene quaternized amines having the general formula:

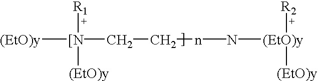

wherein y is from about 2 to about 50, preferably from about 5 to about 30, and n is from about 1 to about 40, preferably from about 2 to about 40 and R1 and R2 are independently a C₁-C₂₀ hydrocarbon. Particularly preferred for use herein is an ethoxylated polyethylene amine, in particular an ethoxylated polyethylene amine wherein n=2 and y=20, and an ethoxylated polyethylene amine wherein n=40 and y=7.

Particularly preferred herein is 24-Ethoxylated Hexamethylene Diamine Quaternized methyl chloride (EHDQ), commercially available from BASF under the trade name Lutensit K-HD 96®.

Thickener

The compositions according to the present invention may comprise as a highly preferred, but optional ingredient a thickener.

Preferred compositions of the present invention may have a viscosity of about 1 cps or greater, more preferably of from about 5 to about 5000 cps, and still more preferably of from about 10 to about 2500 cps when measured with a CSL² 100® Rheometer at about 20° C. with a 4 cm spindle (linear increment from about 10 to about 100 dyne/cm² in 2 minutes).

Typically, the bleaching compositions according to the present invention may comprise from about 0.001% to about 10%, preferably from about 0.05% to about 5% and more preferably from about 0.1% to about 1.0% by weight of the total composition of a thickener.

Alkoxylated Benzoic Acid

The compositions according to the present invention, preferably the compositions according to the present invention used in a process of treating a fabric, as described herein, may comprise as a highly preferred, but optional ingredient a an alkoxylated benzoic acid or a salt thereof.

Generally, the alkoxylated benzoic acid or the salt thereof has the general formula:

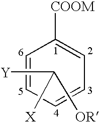

wherein: the substituents of the benzene ring X and Y are independently selected from —H, or —OR′; R′ is independently selected from C₁ to C₂₀ linear or branched alkyl chains, preferably R′ is independently selected from C₁ to C₅ linear or branched alkyl chains, more preferably R′ is —CH₃, and; M is hydrogen, a cation or a cationic moiety. Preferably, M is selected from the group consisting of hydrogen, alkali metal ions and alkaline earth metal ions. More preferably, M is selected from the group consisting of hydrogen, sodium and potassium. Even more preferably, M is hydrogen.

Preferably, said alkoxylated benzoic acid or a salt thereof, is selected from the group consisting of: a monoalkoxy benzoic acid, or a salt thereof, a dialkoxy benzoic acid, or a salt thereof; a trialkoxy benzoic acid, or a salt thereof; and a mixture thereof. More preferably, said alkoxylated benzoic acid or a salt thereof, is selected from the group consisting of: a dialkoxy benzoic acid, or a salt thereof; a trialkoxy benzoic acid, or a salt thereof; and a mixture thereof. Even more preferably, said alkoxylated benzoic acid or a salt thereof, is a trimethoxy benzoic acid or a salt thereof.

In a highly preferred embodiment of the present invention, said alkoxylated benzoic acid or the salt thereof is a trimethoxy benzoic acid or a salt thereof (TMBA), wherein in the above general formula: the substituents of the benzene ring Y and X are —OR′; R′ is —CH₃ and; M is hydrogen, a cation or a cationic moiety.

Preferably, said alkoxylated benzoic acid or the salt thereof is selected from the group consisting of 3,4,5,-trimethoxy benzoic acid, a salt thereof, 2,3,4-trimethoxy benzoic acid, a salt thereof, 2,4,5-trimethoxy benzoic acid, a salt thereof and a mixture thereof. More preferably, said alkoxylated benzoic acid or the salt thereof is 3,4,5,-trimethoxy benzoic acid or a salt thereof. Even more preferably, said alkoxylated benzoic acid or the salt thereof is 3,4,5,-trimethoxy benzoic acid.

Suitable monoalkoxy benzoic acids or salts thereof are commercially available from Aldrich, in particular m-methoxy benzoic acid is commercially available from Aldrich. Suitable trimethoxy benzoic acids or salts thereof are commercially available from Aldrich and Merck.

Typically, the bleaching composition according to the present invention may comprise from about 0.001% to about 5%, preferably from about 0.005% to about 2.5% and more preferably from about 0.01% to about 1.0% by weight of the total composition of said alkoxylated benzoic acid or a salt thereof.

Builder

The bleaching compositions of the present invention may further comprise one or more builders and/or a modified polycarboxylate co-builder.

Suitable builders are selected from the group consisting of: organic acids and salts thereof, polycarboxylates; and mixtures thereof. Typically said builders have a calcium chelating constant (pKCa) of at least about 3. Herein the pKCa the value of a builder or a mixture thereof is measured using a 0.1M NH₄Cl—NH₄OH buffer (pH 10 at 25° C.) and a 0.1% solution of said builder or mixture thereof with a standard calcium ion electrode.

Examples of builders are organic acids like citric acid, lactic acid, tartaric acid, oxalic acid, malic acid, monosuccinic acid, disuccinic acid, oxydisuccinic acid, carboxymethyl oxysuccinic acid, diglycolic acid, carboxymethyl tartronate, ditartronate and other organic acid or mixtures thereof.

Suitable salts of organic acids include alkaline, preferably sodium or potassium, alkaline earth metal, ammonium or alkanolamine salts.

Such organic acids and the salts thereof are commercially available from Jungbunzlaur, Haarman & Reimen, Sigma-Aldrich or Fluka.

Other suitable builders include a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt or “overbased”. When utilized in salt form, alkali metals, such as sodium, potassium, and lithium, or alkanolammonium salts are preferred.

Useful polycarboxylates include homopolymers of acrylic acid and copolymers of acrylic acid and maleic acid.

Other useful polycarboxylate builders include the ether hydroxypolycarboxylates, copolymers of maleic anhydride with ethylene or vinyl methyl ether, 1,3,5-trihydroxy benzene-2,4,6-trisulfonic acid, and carboxymethyloxysuccinic acid, the various alkali metal, ammonium and substituted ammonium salts of polyacetic acids such as nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Suitable polycarboxylates are commercially available from Rohm & Haas under the trade name Norasol® or Acusol®.

Preferred builders herein are selected from the group consisting of: citric acid; tartaric acid; tartrate monosuccinate; tartrate disuccinate; lactic acid; oxalic acid; and malic acid; and mixtures thereof. Even more preferred builders herein are selected from the group consisting of: citric acid; tartaric acid; tartrate monosuccinate; tartrate disuccinate; and malic acid; and mixtures thereof. The most preferred builders herein are selected from the group consisting of: citric acid; tartaric acid; tartrate monosuccinate; and tartrate disuccinate; and mixtures thereof.

Typically the bleaching compositions herein may comprise up to about 40%, preferably from about 0.01% to about 25%, more preferably from about 0.1% to about 15%, and most preferably from about 0.5% to about 10% by weight of the total composition of said builder.

The compositions of the present invention may further comprise a modified polycarboxylate co-builder.

The term “polycarboxylate” refers to compounds having a plurality of carboxylate groups, preferably at least 3 carboxylates.

By “modified polycarboxylate” it is meant herein that at least at one end of the polycarboxylate compound, i.e., the polycarboxylate chain, said compound is modified by a functional group, e.g., a phosphono group.

Preferred modified polycarboxylate co-builders are polycarboxylates with phosphono end groups.

By “phosphono end group” it is meant herein a phosphono functional group according to the formula:

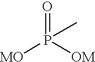

wherein each M is independently H or a cation, preferably both M are H.

Examples of suitable polycarboxylates with phosphono end groups are copolymers of acrylic acid and maleic acid having a phosphono end group and homopolymers of acrylic acid having a phosphono end group.

A preferred modified polycarboxylate is a copolymer of acrylic acid and maleic acid with a phosphonic/phosphono end group according to the general formula:

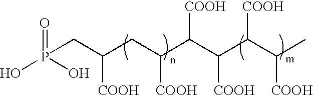

having an average molecular weight of from about 1000 to about 100000, preferably an average molecular weight of from about 1000 to about 20000, more preferably an average molecular weight of from about 1000 to about 10000, and most preferably an average molecular weight of from about 1500 to about 5000; wherein n is from about 10 mol % to about 90 mol %, preferably about 80 mol % and m is from about 10 mol % to about 90 mol %, preferably about 20 mol %.

Accordingly, an example of a suitable modified polycarboxylate is a copolymer of acrylic acid and maleic acid (80/20) with a phosphonic/phosphono end group according to the formula:

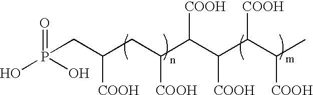

wherein n is about 80 mol % and m is about 20 mol %; having an average molecular weight of about 2000.

Such modified polycarboxylate are available from Rohm & Haas under the trade name Acusol 425®, Acusol 420® or Acusol 470®.

Typically the bleaching compositions herein may comprise up to about 40%, preferably from about 0.01% to about 25%, more preferably from about 0.1% to about 15%, and most preferably from about 0.5% to about 5% by weight of the total composition of said modified polycarboxylate co-builder.

Chelating Agents

The bleaching compositions of the present invention may comprise a chelating agent as a preferred optional ingredient. Suitable chelating agents may be any of those known to those skilled in the art, such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

A chelating agent may be desired in the compositions of the present invention as it allows to increase the ionic strength of the compositions herein and thus their stain removal and bleaching performance on various surfaces. The presence of chelating agents may also contribute to reduce the tensile strength loss of fabrics and/or color damage, especially in a laundry through the wash application. Indeed, the chelating agents inactivate the metal ions present on the surface of the fabrics and/or in the cleaning compositions (neat or diluted) that otherwise would contribute to the radical decomposition of the peroxygen bleach.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUESTS®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer, have been extensively described in U.S. Pat. No. 4,704,233, Nov. 3, 1987, to Hartman and Perkins. Ethylenediamine N,N′-disuccinic acid is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula:

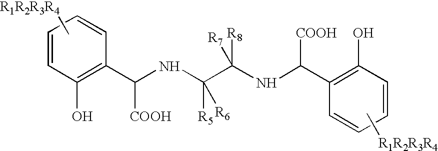

wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein, are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the bleaching compositions according to the present invention may comprise up to about 5%, preferably from about 0.01% to about 1.5% by weight and more preferably from about 0.01% to about 0.5% by weight of the total composition of a chelating agent.

Solvents

The bleaching compositions according to the present invention may further comprise a solvent.

Preferred solvents herein include hydrophobic solvents, hydrophilic solvents and mixtures hereof.

To define the hydrophilic or hydrophobic character of a solvent herein, the following hydrophilic index (HI) is used:

$$\frac{\begin{matrix}molecular weight of the \\ hydrophilic part of the solvent\end{matrix}}{total molecular weight of the solvent} * 100$$

By “hydrophilic part” of a given solvent it is meant herein all the groups O, CO, OH, of a given solvent.

By “molecular weight of the hydrophilic part of a solvent” it is meant herein the total molecular weight of all the hydrophilic parts of a given solvent.

The hydrophilic solvents to be used herein have a hydrophilic index of more than 18, preferably more than 25, and more preferably more than 30, and the hydrophobic solvents to the used herein have a hydrophilic index of less than 18, preferably less than 17 and more preferably 16 or less.

Suitable hydrophobic solvents to be used herein include paraffins, terpenes or terpene derivatives, as well as alkoxylated aliphatic or aromatic alcohols, aliphatic or aromatic alcohols, glycols or alkoxylated glycols, and mixtures thereof, all these solvents have a hydrophilic index of less than 18.

Suitable terpenes (hydrophilic index of 0) are mono-and bicyclic monoterpenes, especially those of the hydrocarbon class, which include the terpinenes, terpinolenes, limonenes and pinenes and mixtures thereof. Highly preferred materials of this type are d-limonene, dipentene, alpha-pinene and/or beta-pinene. For example, pinene is commercially available form SCM Glidco (Jacksonville) under the name Alpha Pinene P&F®.

Terpene derivatives such as alcohols, aldehydes, esters, and ketones, which have a hydrophilic index of less than 18, can also be used herein. Such materials are commercially available as, for example, the α and β isomers of terpineol and linalool.

All type of paraffins (hydrophilic index of 0) can be used herein, both linear and branched, containing from 2 to 20, preferably from 4 to 10, more preferably from 6 to 8 carbon atoms. Preferred herein is octane. Octane is commercially available for example from BASF.

Suitable hydrophobic alkoxylated aliphatic or aromatic alcohols to be used herein are according to the formula R—(A)ₙ—OH wherein R is a linear or branched saturated or unsaturated alkyl group, or alkyl substituted or non-alkyl substituted aryl group of from 1 to 20, preferably from 2 to 15 and more preferably from 2 to 10 carbon atoms, wherein A is an alkoxy group preferably an butoxy, propoxy and/or ethoxy group, and n is an integer of from about 1 to about 5, preferably about 1 to about 2. Suitable hydrophobic alkoxylated alcohol to be used herein is 1-methoxy-11-dodecanol (HI=15).

Suitable hydrophobic aliphatic or aromatic alcohols to be used herein are according to the formula R—OH wherein R is a linear or branched saturated or unsaturated alkyl group, or alkyl substituted or non-alkyl substituted aryl group of from 1 to 20, preferably from 2 to 15 and more preferably from 2 to 10 carbon atoms. Suitable aliphatic alcohols to be used herein include linear alcohols like decanol (HI=7). Suitable aromatic alcohol to be used herein is benzyl alcohol (HI=16).

Suitable hydrophobic glycols to be used herein are according to the formula HO—CR₁R₂—OH wherein R₁ and R₂ are independently H or a C₂-C₁₀ saturated or unsaturated aliphatic hydrocarbon chain and/or cyclic hydrocarbon chain. Suitable glycol to be used herein is dodecaneglycol (HI=16).

Suitable hydrophobic alkoxylated glycols to be used herein are according to the formula R—(A)ₙ—R₁—OH wherein R is H, OH, a linear saturated or unsaturated alkyl of from 1 to 20, preferably from 2 to 15 and more preferably from 2 to 10 carbon atoms, wherein R₁ is H or a linear saturated or unsaturated alkyl of from 1 to 20, preferably from 2 to 15 and more preferably from 2 to 10 carbon atoms, and A is an alkoxy group preferably an ethoxy, methoxy, and/or propoxy group and n is from about 1 to about 5, preferably about 1 to about 2. Suitable alkoxylated glycol to be used herein is methoxy octadecanol (HI=11).

Particularly preferred hydrophobic solvents to be used herein include d-limonene, dipentene, alpha-pinene, beta-pinene, octane, benzyl alcohol, or mixtures thereof.

Suitable hydrophilic solvents to be used herein include alkoxylated aliphatic or aromatic alcohols, aliphatic or aromatic alcohols, glycols or alkoxylated glycols, and mixtures thereof, all these solvents having a hydrophilic index of more than 18.

Suitable hydrophilic alkoxylated aliphatic or aromatic alcohols to be used herein are according to the formula R—(A)ₙ—OH wherein R is a linear or branched saturated or unsaturated alkyl group, or alkyl substituted or non-alkyl substituted aryl group of from 1 to 20, preferably from 2 to 15 and more preferably from 2 to 10 carbon atoms, wherein A is an alkoxy group preferably a butoxy, propoxy and/or ethoxy group, and n is an integer of from 1 to 5, preferably 1 to 2. Particularly suitable alkoxylated alcohols to be used herein include methoxy propanol (HI=37), ethoxy propanol (HI=32), propoxy propanol (HI=28) and/or butoxy propanol (HI=27).

Suitable hydrophilic aliphatic or aromatic alcohols to be used herein are according to the formula R—OH wherein R is a linear or branched saturated or unsaturated alkyl group, or alkyl substituted or non-alkyl substituted aryl group of from 1 to 20, preferably from 2 to 15 and more preferably from 2 to 10 carbon atoms. Particularly suitable aliphatic alcohols to be used herein include linear alcohols like ethanol (HI=37) and/or propanol (HI=28).

Suitable hydrophilic glycols to be used herein are according to the formula HO—CR₁R₂—OH wherein R₁ and R₂ are independently H or a C₂-C₁₀ saturated or unsaturated aliphatic hydrocarbon chain and/or cyclic hydrocarbon chain. Particularly suitable glycol to be used herein is propanediol (HI=45).

Suitable hydrophilic alkoxylated glycols to be used herein are according to the formula R—(A)ₙ—R₁—OH wherein R is H, OH, a linear saturated or unsaturated alkyl group of from 1 to 20, preferably from 2 to 15 and more preferably from 2 to 10 carbon atoms, wherein R₁ is H or a linear saturated or unsaturated alkyl group of from 1 to 20, preferably from 2 to 15 and more preferably from 2 to 10 carbon atoms, and A is an alkoxy group preferably an ethoxy, methoxy, and/or propoxy group and n is from about 1 to about 5, preferably about 1 to about 2. A particularly suitable alkoxylated glycol to be used herein is ethoxyethoxyethanol (HI=37).

Typically, the bleaching compositions according to the present invention may comprise up to about 30%, preferably from about 0.01% to about 15%, more preferably from about 0.1% to about 10%, and most preferably from about 0.5% to about 5% by weight of the total composition of a solvent.

In a preferred embodiment wherein the compositions herein comprise a mixture of a hydrophobic solvent and a hydrophilic solvent the weight ratio of said hydrophobic solvent to said hydrophilic is from about 1:20 to about 1:1, more preferably from about 1:14 to about 1:2.

Solvents, when present, contribute to the excellent stain removal performance of the bleaching compositions as described herein.

Foam Reducing Agent or System

The bleaching compositions according to the present invention may further comprise a foam reducing agent or a foam reducing system. Any foam reducing agents known to those skilled in the art are suitable for use herein. In a preferred embodiment a foam reducing system comprising a fatty acid together with a capped alkoxylated nonionic surfactant as defined herein after and/or silicone is used.

Typically, the bleaching compositions herein may comprise from about 1·10⁻⁴% to about 10%, preferably from about 1·10⁻³% to about 5% and more preferably from about 1·10⁻²% to about 5% by weight of the total composition of a fatty acid.

Typically, the bleaching compositions herein may comprise from about 1·10⁻³% to about 20%, preferably from about 1·10⁻²% to about 10% and more preferably from about 5·10⁻²% to about 5% by weight of the total composition of a capped alkoxylated nonionic surfactant as defined herein.

Typically, the bleaching compositions herein may comprise from about 1·10⁻⁵% to about 5%, preferably from about 1·10⁻⁵% to about 1% and more preferably from about 1·10⁻⁴% to about 0.5% by weight of the total composition of a silicone.

Suitable fatty acids for use herein are the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms.

Suitable fatty acids may be selected from caprylic acid, capric acid, lauric acid, myristic acid, palmitic acid, stearic acid, and mixtures of fatty acids suitably hardened, derived from natural sources such as plant or animal esters (e.g., palm oil, coconut oil, soybean oil, castor oil, tallow, ground oil, whale and fish oils and/or babassu oil.

For example Coconut Fatty Acid is commercially available from UNICHEMA under the name PRIFAC 5900®.

Suitable capped alkoxylated nonionic surfactants for use herein are according to the formula:

R₁(O—CH₂—CH₂)ₙ—(OR₂)ₘ—O—R₃

wherein R₁ is a C₈-C₂₄ linear or branched alkyl or alkenyl group, aryl group, alkaryl group, preferably R₁ is a C₈-C₁₈ alkyl or alkenyl group, more preferably a C₁₀-C₁₅ alkyl or alkenyl group, even more preferably a C₁₀-C₁₅ alkyl group;

wherein R₂ is a C₁-C₁₀ linear or branched alkyl group, preferably a C₂-C₁₀ linear or branched alkyl group, preferably a C₃ group;

wherein R₃ is a C₁-C₁₀ alkyl or alkenyl group, preferably a C₁-C₅ alkyl group, more preferably methyl;

and wherein n and m are integers independently ranging in the range of from 1 to 20, preferably from 1 to 10, more preferably from 1 to 5; or mixtures thereof.

These surfactants are commercially available from BASF under the trade name Plurafac®, from HOECHST under the trade name Genapol® or from ICI under the trade name Symperonic®. Preferred capped nonionic alkoxylated surfactants of the above formula are those commercially available under the tradename Genapol® L 2.5 NR from Hoechst, and Plurafac® from BASF.

Suitable silicones for use herein include any silicone and silica-silicone mixtures. Silicones can be generally represented by alkylated polysiloxane materials while silica is normally used in finely divided forms exemplified by silica aerogels and xerogels and hydrophobic silicas of various types. These materials can be incorporated as particulates in which the silicone is advantageously releasably incorporated in a water-soluble or water-dispersible, substantially non-surface-active detergent impermeable carrier. Alternatively, the silicone can be dissolved or dispersed in a liquid carrier and applied by spraying on to one or more of the other components.

Actually in industrial practice, the term “silicone” has become a generic term, which encompasses a variety of relatively high-molecular-weight polymers containing siloxane units and hydrocarbyl groups of various types. Indeed, silicone compounds have been extensively described in the art, see for instance U.S. Pat. No. 4,076,648, U.S. Pat. No. 4,021,365, U.S. Pat. No. 4,749,740, U.S. Pat. No. 4,983,316, EP 150 872, EP 217 501 and EP 499 364. The silicone compounds disclosed therein are suitable in the context of the present invention. Generally, the silicone compounds can be described as siloxanes having the general structure:

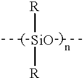

wherein n is from about 20 to about 2000, and where each R independently can be an alkyl or an aryl radical. Examples of such substituents are methyl, ethyl, propyl, isobutyl, and phenyl. Preferred polydiorganosiloxanes are polydimethylsiloxanes having trimethylsilyl end blocking units and having a viscosity at 25° C. of from about 5×10⁻⁵ m²/s to about 0.1 m²/s, i.e., a valve of n in the range about 40 to about 1500. These are preferred because of their ready availability and their relatively low cost.

A preferred type of silicone compounds useful in the compositions herein comprises a mixture of an alkylated siloxane of the type herein above disclosed and solid silica.

The solid silica can be a fumed silica, a precipitated silica or a silica made by the gel formation technique. The silica particles can be rendered hydrophobic by treating them with diakylsilyl groups and/or trialkylsilane groups either bonded directly onto the silica or by means of silicone resin. A preferred silicone compound comprises a hydrophobic silanated, most preferably trimethylsilanated silica having a particle size in the range from about 10 mm to about 20 mm and a specific surface area above about 50 m²/g. Silicone compounds employed in the compositions according to the present invention suitably have an amount of silica in the range of about 1 to about 30% (more preferably about 2 to about 15%) by weight of the total weight of the silicone compounds resulting in silicone compounds having an average viscosity in the range of from about 2×10⁻⁴ m²/s to about 1 m²/s. Preferred silicone compounds may have a viscosity in the range of from about 5×10⁻³ m²/s to about 0.1 m²/s. Particularly suitable are silicone compounds with a viscosity of about 2×10⁻² m²/s or about 4.5×10⁻² m²/s.

Suitable silicone compounds for use herein are commercially available from various companies including Rhone Poulenc, Fueller and Dow Corning. Examples of silicone compounds for use herein are Silicone DB® 100 and Silicone Emulsion 2-3597® both commercially available from Dow Corning.

Another silicone compound is disclosed in Bartollota et al. U.S. Pat. No. 3,933,672. Other particularly useful silicone compounds are the self-emulsifying silicone compounds, described in German Patent Application DTOS 2 646 126 published Apr. 28, 1977. An example of such a compound is DC-544®, commercially available from Dow Corning, which is a siloxane-glycol copolymer.

Typically preferred silicone compounds are described in European Patent application EP-A-573699. Said compositions can comprise a silicone/silica mixture in combination with fumed nonporous silica such as Aerosil®.

Antioxidant

The bleaching compositions according to the present invention may further comprise an antioxidant.

Typically, the bleaching compositions herein may comprise up to about 10%, preferably from about 0.002% to about 5%, more preferably from about 0.005% to about 2%, and most preferably from about 0.01% to about 1% by weight of the total composition of an antioxidant.

Suitable antioxidants to be used herein include organic acids like citric acid, ascorbic acid, tartaric acid, adipic acid and sorbic acid, or amines like lecithin, or aminoacids like glutamine, methionine and cysteine, or esters like ascorbil palmitate, ascorbil stearate and triethylcitrate, or mixtures thereof. Preferred antioxidants for use herein are citric acid, ascorbic acid, ascorbil palmitate, lecithin or mixtures thereof.

Bleach Activator

As an optional ingredient, the compositions of the present invention may comprise a bleach activator. By “bleach activator”, it is meant herein a compound, which reacts with hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). Also suitable are N-acyl caprolactams selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmental-friendly as it eventually degrades into citric acid and alcohol. Furthermore, acetyl triethyl citrate has a good bydrolytical stability in the product upon storage and it is an efficient bleach activator. Finally, it provides good building capacity to the composition.

The bleaching compositions according to the present invention may comprise from about 0.01% to about 20%, preferably from about 1% to about 10%, and more preferably from about 3% to about 7% by weight of the total composition of said bleach activator.

Sulphonated Hydrotrope

The bleaching compositions according to the present invention may further comprise a sulphonated hydrotrope.

Any sulphonated hydrotropes known to those skilled in the art are suitable for use herein. In a preferred embodiment alkyl aryl sulphonates or alkyl aryl sulphonic acids are used. Preferred alkyl aryl sulphonates include sodium, potassium, calcium and ammonium xylene sulphonates, sodium, potassium, calcium and ammonium toluene sulphonates, sodium, potassium, calcium and ammonium cumene sulphonates, sodium, potassium, calcium and ammonium substituted or unsubstituted naphthalene sulphonates and mixtures thereof. Preferred alkyl aryl sulphonic acids include xylenesulphonic acid, toluenesulphonic acid, cumenesulphonic acid, substituted or unsubstituted naphthalenesulphonic acid and mixtures thereof. More preferably, xylenesulphonic acid or p-toluene sulphonate or mixtures thereof are used.

Typically, the bleaching compositions herein comprise from about 0.01% to about 20% by weight of the total composition of a sulphonated hydrotrope, preferably from about 0.05% to about 10% and more preferably from about 0.1% to about 5%.

Article of Manufacture

The present invention also relates to articles of manufacture comprising (1) a solid or liquid bleach composition, preferably liquid bleach composition, comprising peroxygen bleach and optionally but highly preferably a color protection agent comprising dye maintenance agent and/or color safety ingredient, in a package, and (2) a set of instructions associated with the package, said set of instructions including an instruction to safely bleach and/or remove stain from white and colored fabric items, including dark colored and/or black colored fabric items, through the use of the bleach composition as described above.

As used herein, the term “liquid” means to include conventional liquids, gels and pastes, and the term “solid” means compositions in the dry form, including powder or granular.

As used herein, the phrase “in association with” means that the set of instructions is directly printed on the container and/or the packaging for the container, or presented with the container in a separate manner, including but not limited to, a brochure, print advertisement, electronic advertisement, and/or verbal communication. A variety of compositions, packaging and information can be utilized in the articles of the present invention. The set of instructions preferably comprises an instruction to instruction to direct the consumer to contact said fabric with an effective amount of said bleach composition in its neat or diluted form and wash said fabric with an aqueous bath comprising water and a conventional laundry detergent before and/or during and/or after the step of contacting said fabrics with said composition, to safely bleach and/or remove stain while minimizing damage or without causing damage to said color fabric.

Suitable containers herein are selected from the group consisting of plastic bottles, glass bottles and the like. Suitable plastic bottles are made of synthetic organic polymeric plastic materials. In a preferred embodiment according to the present invention, the container herein is a plastic bottle.

By ‘dark colored fabric items’ it is meant herein, any kind of fabric item having a dark color, wherein said dark color is provided to said fabric item by any means known to those skilled in the art. Preferably, said dark colored fabric items are fabric items dyed with fabric dyes providing a dark color to said fabric item.

By ‘dark color’ it is meant herein a color having a luminosity dimension L* (CIE L*a*b* color model) of from about 35 to about 0, preferably about 25 to about 0, more preferably, about 15 to about 0. Examples of such dark colors include, but are not limited to, black, dark brown, anthracite, dark gray, dark blue, dark green and the like.

The ‘luminosity dimension L*’ defines the lightness or grayscale axis of a color on a scale ranging from 0 (black) to 100 (white). The Luminosity dimension L* is defined in the CIE L*a*b* color model (CIELAB), published in 1976 by the Commission Internationale de l'Éclairage (CIE) or International Commission on Illumination (ICC). The luminosity dimension L* is closely related to the lightness or value of a color as defined in the Munsell's value axis (Munsell scale), ranging from 1 to 10, except that the value of each step is much greater.

By ‘fabric item’ it is meant herein any kind of textile item made of natural (such as cotton or wool and the like) and/or synthetic (such as polyester, nylon, lycra and the like) material. Suitable fabric items herein include, but are not limited to: clothes, such as shirts, trousers, skirts, underwear, sweaters, jackets, coats and the like; house textiles, such as bath linens, bed linens, kitchen cloths, tablecloths, handkerchiefs, napkins and the like; curtains; drapes; sleeping bags; tents etc.

Suitable dark colored fabric items herein are colored by a single dark color as described herein above, or are colored by any kind of pattern or design composed of a multitude of dark colors as described herein above or a pattern or design composed of a mixture of at least one dark color as described herein above and at least one light color, wherein said dark color or dark colors constitute at least about 50%, preferably about 60%, more preferably about 75%, of the total surface area of said pattern or design.

In a preferred embodiment according to the present invention said dark colored fabric items are colored by a color having a luminosity dimension L* (CIE L*a*b* color model) of from about 35 to about 0, preferably about 25 to about 0, more preferably about 15 to about 0. Most preferably, said dark colored fabric items are colored by a color having a luminosity dimension L* (CIE L*a*b* color model) of about 0, which is black.

In another preferred embodiment according to the present invention, said dark colored fabric items are black or have a pattern or design composed of a mixture of black and other colors, wherein at least 50%, preferably about 60%, more preferably about 75%, of the total surface area of said pattern or design is black.

A set of instructions is essential to obtaining the benefits of the present invention because consumers are unaware of such benefits. More specifically, consumers are not aware that the use of such a bleach composition, especially those comprising a color protection agent which comprises dye maintenance agent and/or color safety ingredient, preferably dye maintenance agent, can safely and effectively bleach and/or remove stain from colored fabric, including dark and/or black colored fabric, without causing damage or significantly reducing the damage to the color of said colored fabric. . As such, a set of instructions provided in association with the bleach composition is essential for the consumer to enjoy the benefits of the present invention.

In a preferred embodiment herein, the article of manufacture herein can in addition to the instructions bear an additional indication comprising a term selected from the group consisting of: noir, black, bleach for blacks, bleach noir, dark bleach, bleach for darks, bleach dark colors, bleach for black colors, for black fabrics, for dark fabrics, negro, nero, preto, schwarz, dark, oscuro, escuro, scuro, and the like, and combinations thereof. Preferably, said additional indication comprises a term selected from the group consisting of: noir, black, dark, bleach for blacks, bleach noir, dark bleach, bleach for darks and the like, and combinations thereof. More preferably, said additional indication comprises a term selected from the group consisting of: noir, black, dark, and the like, and combinations thereof. Said additional indication further specifies that the liquid bleaching composition herein is suitable for the treatment of dark colored fabric items.

Depending on the concentration of the peroxygen bleach and the color protection agent in the liquid bleach composition, the set of instructions preferably comprises an instruction to direct the consumer to apply an effective amount of the liquid bleach composition, in order to provide an effective level of the peroxygen bleach and a color protection agent to fabric to achieve the desired benefit. Typically an effective level of liquid bleach composition in diluted condition is an amount that provides from about 1 to about 15 grams, preferably from about 2 to about 10, and more preferably from about 2.5 to about 5 grams of peroxygen bleach per kilogram of dry fabric. Typically an effective level of liquid bleach composition in neat condition is an amount that provides from about 25 to about 100 grams, preferably from about 30 to about 75, and more preferably from about 40 to about 60 grams of peroxygen bleach per kilogram of dry fabric.

The set of instructions associated with the use and/or benefits of the bleach composition, article and/or method of the present invention can be provided via different means using a variety of media including electronic or print or a combination thereof. In one of the most convenient and direct manner, the bleach composition can be marketed in a package and the set of instructions can be provided with the package, printed directly on the package label, on an information sheet provided with the package and/or on point of sale materials. Similarly, the set of instructions can be recorded in various electronic or computer readable forms and provided with the composition package.

It is also preferred to provide the instructions associated with the use and/or benefits of the bleach composition, article, and/or method of the present invention via the mass media, such as the print media and/or the electronic media. Print media include, e.g., newspapers, magazines, journals, newsletters, brochures, billboard presentations, store displays, and the like, in, e.g., hard copy, or virtual, electronic format. Electronic media include means to communicate via electronic means and/or electromagnetic radiation, e.g., television, radio, global computer network, and the like. Electronic or computer readable forms of the set of instructions can be posted and made available to the consumer for downloading from a website located on a global computer network, at an address associated with the bleach composition and/or fabric articles.

Instructions concerning the use of the bleach composition are preferably in consumer-friendly language on packaging and/or in advertising (e.g., leaflets, coupons, displays, etc.). By consumer-friendly language, it is meant that consumers would be instructed how to use the product to achieve the best results. It is important that the instructions are as simple and clear as possible and it is envisioned that pictures, drawings and/or icons can be used, either with or without words to render the instructions more consumer-friendly. The set of instructions can be multi-lingual to be more easily understood by consumers who speak different languages. Special packaging design can also be advantageously used to convey instructions in a consumer-friendly fashion.

The units of measurement provided to consumers will reflect consumer understanding, e.g., English dosing units will be preferred in, e.g., the United States and the United Kingdom, and metric units will be used in, e.g., most European nations. Although all of the compositions and methods described herein are written in metric units, it is understood that these units will be converted into consumer-friendly language instructions in the actual product packaging, advertising etc. Furthermore, the effective levels needed of the essential and optional actives are expressed herein as the amounts of the actives per weight of fabrics, the instructions for use to the consumer will be expressed as amount per use of the bleach composition, when a preferred composition is set.

Associated Instructions

Instructions

The articles and methods of the present invention further comprise a set of instructions in association with the bleach composition. A set of instructions is essential to obtaining the benefits of the present invention because consumers are unaware of such benefits. More specifically, consumers are not aware that a bleach can be used to bleach and/or remove stain from dark or black colored fabric without damaging the color of the fabric.

In general peroxygen bleaches are safe to fabrics, including dark colored fabric items, when compared to other bleaches, as for example hypohalite bleaches. Nevertheless, peroxygen bleaching compositions are considered by the users of such compositions as damaging dark colored fabric items treated therewith. Indeed, the users of said compositions consider said compositions to cause color damage (“discoloration”) of dyed fabric items treated with said compositions, in particular dark colored fabric items. On the contrary, it is submitted that bleaching compositions comprising a peroxygen bleach, especially those additionally comprising the optional color protection agent, show an excellent color safety performance. Indeed, such bleaching compositions show an excellent color safety performance when used on dark colored fabric items and even on black fabric items. Moreover, it has been observed that bleaching compositions comprising a peroxygen bleach reduce or even prevent color bleeding when used to treat colored fabric items. Hence, it is not just that such bleaching compositions do not show a negative effect regarding color safety when treating dark colored fabric items but there is even the beneficial effect of color bleeding reduction or even prevention when treating dark colored fabric items.

Consumers are not aware of such benefits. Furthermore consumers are not aware that certain color protection agents such as dye maintenance agents can be used in certain bleach compositions to protect the color from bleach damage. The consumer needs to know the method of use, and the benefits from following the method of use in order to obtain the full value of the invention. As such, a set of instructions provided in association with the bleach composition is essential for the consumer to enjoy the benefits of the present invention.

Form of the Instructions

The instructions herein, including usage instructions, can be printed directly onto the container herein and/or onto an additional package for the container herein (such as a carton or plastic box) when present. Furthermore, said instructions can be associated to said container and/or to said optional additional package by means of a label comprising the instructions in a printed manner applied to the container and/or said optional additional package. Said label may be glued or by any other means known to those skilled in the art affixed or attached to the container and/or said additional package when present. Moreover, said instructions may be presented with the article of manufacture in a separate manner, including but not limited to, a brochure, print advertisement, electronic advertisement, and/or verbal communication.

The set of instructions associated with the use and/or benefits of the bleach compositions, articles, and/or methods of the present invention can be provided via different means using a variety of media. In the most convenient and direct manner, the bleach composition will be marketed in a package and the set of instructions will be provided with the package, printed directly on the package label, on an information sheet provided with the package or on point of sale materials. Similarly, the set of instructions can be recorded in various electronic or computer readable forms and provided with the composition package.

It is also preferred to provide the instructions associated with the use and/or benefits of the bleach compositions, articles, and/or methods of the present invention via the mass media, such as the print media and/or the electronic media. Print media include, e.g., newspapers, magazines, journals, newsletters, brochures, billboard presentations, store displays, and the like, in, e.g., hard copy, or virtual, electronic format. Electronic media include means to communicate via electronic means and/or electromagnetic radiation, e.g., television, radio, global computer network, and the like. Electronic or computer readable forms can be posted and made available to the consumer for downloading from a website located on a global computer network. It is also preferred that the set of instructions is posted at the point of sale adjacent the package.

Methods of the Present Invention

Method for Bleaching and/or Removing Stain from Dark and/or Black Colored Fabric

The present invention relates to a method for bleaching and/or removing stain from colored fabric, said method comprising the steps of (1) providing a solid or liquid bleach composition, preferably liquid bleach composition comprising peroxygen bleach, and optionally but highly preferably a color protection agent comprising dye maintenance agent and/or color safety ingredient, in a package; and (2) providing a set of instructions associated with the package, said set of instructions comprising an instruction to contact said fabric comprising color fabric with an effective amount of said bleach composition in its neat or diluted form and wash said fabric with an aqueous bath comprising water and a conventional laundry detergent before and/or during and/or after the step of contacting said fabrics with said composition, to safely bleach and/or remove stain without causing damage or minimizing damage to the color of said colored fabric. A full description of various bleach compositions that are useful in this method have been detailed hereinabove and will not be repeated here.

Method of Teaching a Consumer to Safely Bleach and/or Remove Stain from Colored Fabric

The present invention relates to a method for teaching a consumer to bleach and/or remove stain from colored fabric, said method comprising the steps of (1) providing a solid or liquid bleach composition, preferably liquid bleach composition comprising peroxygen bleach and optionally but highly preferably a color protection agent comprising dye maintenance agent and/or color safety ingredient, in a package; and (2) providing a set of instructions associated with the package, wherein the set of instructions comprising an instruction to contact said fabric comprising colored fabric with an effective amount of said bleach composition in its neat or diluted form and wash said fabric with an aqueous bath comprising water and a conventional laundry detergent before and/or during and/or after the step of contacting said fabrics with said composition, to bleach and/or remove stain without causing damage or minimizing damage to the color of said colored fabric. The consumer is informed of the benefit associated with the use of the bleach composition through a set of instructions associated with the liquid bleach composition or with fabric articles. The set of instructions useful for informing the consumer are those described above in association with the articles and/or methods of the present invention.

Method of Promoting the Use of Liquid Bleach Compositions

The present invention relates to a method of promoting the use of solid or liquid bleach composition, preferably liquid bleaching composition, comprising peroxygen bleach and optionally but highly preferably a color protection agent comprising dye maintenance agent and/or color safety ingredient to safely bleach and/or remove stain from colored fabric comprising dark and/or black colored fabric, the method comprising the step of informing a consumer that the treatment of dark and/or black colored fabric with said composition reduces and/or prevents damage to the color of said fabric.

The present invention also relates to a method of promoting the use of bleaching composition comprising peroxygen bleach and a color protection agent comprising dye maintenance agent and/or color safety ingredient to safely bleach and/or remove stain from colored fabric comprising dark and/or black colored fabric, the method comprising the step of informing a consumer that the color protection agent will reduce and/or prevent the damage to the color of said fabric.

### EXAMPLES

The following examples will further illustrate the present invention. The compositions are made by combining the listed ingredients in the listed proportions (weight % unless otherwise specified). The following Examples are meant to exemplify compositions used in a process according to the present invention but are not necessarily used to limit or otherwise define the scope of the present invention.

| Compositions | I | II | III | IV | V | VI | VII | VIII |
|---|---|---|---|---|---|---|---|---|
| Dobanol ® 23-3 | 2.0 | 1.0 | 1.0 | 2.0 | 1.5 | — | — | — |
| Dobanol ® 91-10 | 2.0 | 3.0 | — | — | — | 2.0 | 2.0 | — |
| Marlipal ® 24-7 | — | — | 3.0 | 2.0 | 2.0 | 2.0 | — | |
| | 1.0 | | | | | | | |
| Marlipal ® 24-4 | — | — | — | — | 1.0 | 1.0 | 1.5 | |
| | 1.0 | | | | | | | |
| BHT | — | — | — | — | — | — | — | — |
| Hydrogen Peroxide | 3.5 | 4.0 | 5.0 | 6.0 | 7.0 | 8.0 | 5.0 | |
| | 6.0 | | | | | | | |
| Dye maintenance | 0.05 | 0.1 | 0.2 | 0.5 | 1.0 | 0.1 | 0.3 | |
| agent | 0.05 | | | | | | | |

| | |
|---|---|
| Water and minors | up to 100% |

All examples have a pH of below about 9

| | | | | | | | | |
|---|---|---|---|---|---|---|---|---|
| Compositions | IX | X | XI | XII | XIII | XIV | XV | XVI |
| Dobanol ® 23-3 | — | 0.5 | 1.0 | — | — | — | — | — |
| Dobanol ® 91-10 | — | — | — | — | — | 3.0 | 2.0 | 5.0 |
| Marlipal ® 24-7 | 2.0 | 2.5 | 1.0 | 4.0 | 7.0 | 3.0 | 2.0 | 5.0 |
| Marlipal ® 24-4 | 1.0 | 0.5 | 1.0 | 1.0 | — | — | — | — |
| BHT | — | 0.2 | 0.1 | 0.1 | 0.2 | 0.1 | — | — |
| Hydrogen Peroxide | 8.0 | 6.0 | 7.0 | 4.0 | 5.0 | 6.0 | 7.0 | 8.0 |
| Dye maintenance | 0.1 | 0.05 | 0.5 | 0.2 | 0.1 | 0.5 | 0.5 | 1.0 |
| agent | | | | | | | | |

| | |
|---|---|
| Water and minors | up to 100% |

All examples have a pH of below 9

Dobanol® 23-3 is a C₁₂-C₁₃ EO3 nonionic surfactant commercially available from SHELL.

Dobanol® 45-7 is a C₁₄-C₁₅ EO7 nonionic surfactant commercially available from SHELL.

Dobanol® 91-8 is a C₉-C₁₁ EO8 nonionic surfactant commercially available from SHELL.

Dobanol® 91-10 is a C₉-C₁₁ EO10 nonionic surfactant commercially available from SHELL.

Marlipal® 24-4 is a linear C₁₂-C₁₄ EO4 nonionic surfactant commercially available from Condea.

Marlipal® 24-7 is a linear C₁₂-C₁₄ EO7 nonionic surfactant commercially available from Condea.

Hydrogen Peroxide is commercially available from Ausimont.

Dye maintenance agent is imidazole:epi-chlorohydrin copolymer commercially available under the trade name Sokalan PG-IME® from BASF.

What is claimed is:

1. A process of treating fabrics with a liquid bleaching composition comprising at least about 3% of peroxygen bleach and dye maintenance agent, wherein said process comprises the steps of contacting said fabrics with said liquid composition in its neat or diluted form and washing said fabrics with an aqueous bath comprising water and a conventional laundry detergent before and/or during and/or after the step of contacting said fabrics with said liquid composition.

2. A process according to claim 1, wherein said peroxygen bleach is selected from the group consisting of: hydrogen peroxide; water soluble sources of hydrogen peroxide; organic or inorganic peracids; hydroperoxides; and diacyl peroxides; and mixtures thereof.

3. A process according to claim 1, wherein said bleaching composition as is has a pH, measured at 25° C., of no more than about 9.

4. A process according to claim 1, wherein said bleaching composition comprises from about 3% to about 30% by weight of the total composition of said peroxygen bleach.

5. A process according to claim 1, wherein said dye maintenance agent is a cyclic amine based polymer, oligomer or copolymer.

6. A process according to claim 5, wherein said dye maintenance agent is a cyclic amine based polymer, oligomer or copolymer of the general formula: 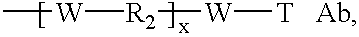
wherein each T is independently selected from the group consisting of: H, C₁-C₁₂ alkyl, substituted alkyl, C₇-C₁₂ alkylaryl,
—(CH₂)ₕCOOM, —(CH₂)ₕSO₃M, CH₂CH(OH)SO₃M, —(CH₂)ₕOSO₃M, 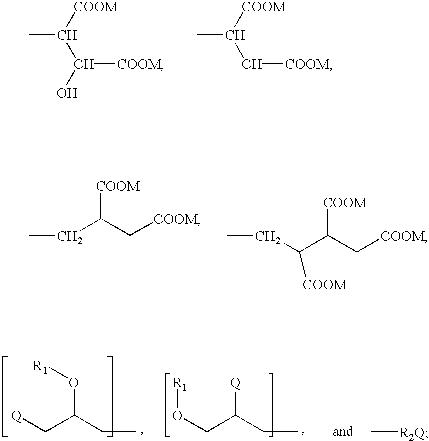
wherein W comprises at least one cyclic constituent selected from the group consisting of: 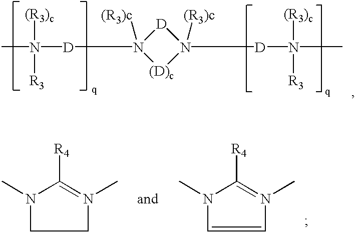
in addition to the at least one cyclic constituent, W may also comprise an aliphatic or substituted aliphatic moiety of the general structure; 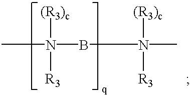
each B is independently C₁-C₁₂ alkylene, C₁-C₁₂ substituted alkylene, C₃-C₁₂ alkenylene, C₈-C₁₂ dialkylarylene, C₈-C₁₂ dialkylarylenediyl, and —(R₅O)ₙR₅—;
each D is independently C₂-C₆ alkylene;
each Q is independently selected from the group consisting of hydroxy, C₁-C₁₈ alkoxy, C₂-C₁₈ hydroxy alkoxy, amino, C₁-C₁₈ alkyl amino, dialkyl amino, trialkyl amino groups, heterocyclic monoamino groups and diamine groups;
each R₁ is independently selected from the group consisting of H, C₁-C₈ alkyl and C₁-C₈ hydroxyalkyl;
each R₂ is independently selected from the group consisting of: C₁-C₁₂ alkylene, C₁-C₁₂ alkenylene, —CH₂—CH(OR₁)—CH₂, C₈-C₁₂ alkarylene, C₄-C₁₂ dihydroxy alkylene, poly(C₂-C₄ alkyleneoxy) alkylene, H₂CH(OH)CH₂OR₂OCH₂CH(OH)CH₂—, and C₃-C₁₂ hydrocarbyl moieties;
provided that when R₂ is a C₃-C₁₂ hydrocarbyl moiety the hydrocarbyl moiety can comprise from about 2 to about 4 branching moieties of the general structure: 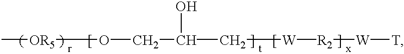
each R₃ is independently selected from the group consisting of: H, R₂, O, C₁-C₂₀ hydroxyalkyl, C₁-C₂₀ alkyl, substituted alkyl, C₆-C₁₁ aryl, substituted aryl, C₇-C₁₁ alkylaryl, C₁-C₂₀ aminoalkyl,
—(CH₂)ₕCOOM, —(CH₂)ₕSO₃M, CH₂CH(OH)SO₃M, —(CH₂)ₕOSO₃M, 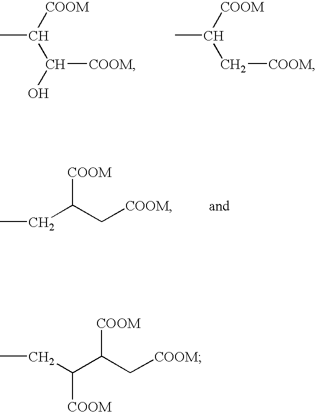
wherein at least 10 mole % of the R₃ groups are O, provided that O is only present on a tertiary N;
each R₄ is independently selected from the group consisting of: H, C₁-C₂₂ alkyl, C₁-C₂₂ hydroxyalkyl, aryl and C₇-C₂₂ alkylaryl;
each R₅ is independently selected from the group consisting of: C₂-C₈ alkylene, C₂-C₈ alkyl substituted alkylene; and
A is a compatible monovalent or di or polyvalent anion;
M is a compatible cation;
and wherein b=number necessary to balance the charge; each x is independently from 3 to 1000; each c is independently 0 or 1; each h is independently from 1 to 8; each q is independently from 0 to 6; each n is independently from 1 to 20; each r is independently from 0 to 20; and each t is independently from 0 to 1.

7. A process according to claim 6, wherein each R₁ is H and at least one W is selected from the group consisting of:

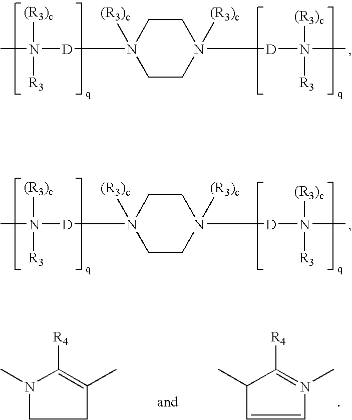

8. A process according to claim 7, wherein R₁ is H and at least one W is selected from the group consisting of:

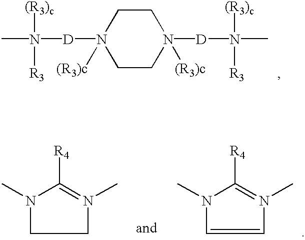

9. A process according to claim 8, wherein each R₁ is H and at least one W is selected from the group consisting of:

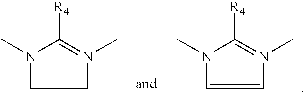

10. A process according to claim 6, wherein said cyclic amine based polymers, oligomers or copolymers are oxidized adducts selected from the group consisting of piperazine, piperidine, epichlorohydrin, epichlorohydrin benzyl quat, epichlorohydrin methyl quat, morpholine and mixtures thereof.

11. A process according to claim 1, wherein said bleaching composition comprises from about 0.001% to about 30% by weight of the total composition of said dye maintenance agent.

12. A process according to claim 1, wherein the liquid bleaching composition comprises from about 4.5% to about 15% of peroxygen bleach selected from the group consisting of: hydrogen peroxide; water soluble sources of hydrogen peroxide; organic or inorganic peracids; hydroperoxides; and diacyl peroxides; and mixtures thereof, and from about 0.01% to about 15% of dye maintenance agent being cyclic amine based polymer, oligomer or copolymer, and wherein said bleaching composition as is has a pH, measured at 25° C., of from about 4 to about 8.

13. An article of manufacture for bleaching and/or removing stain from colored fabric, the article comprising:
a solid or liquid bleach composition comprising peroxygen bleach and optionally a color protection agent comprising dye maintenance agent and/or color safety ingredient, in a package; and
a set of instructions associated with the package, wherein the set of instructions comprises an instruction to contact the colored fabric with an effective amount of the bleach composition and wash the fabric with an aqueous bath comprising water and a conventional laundry detergent before and/or during and/or after the step of contacting the fabric with the composition, to bleach and/or remove stain without causing damage or minimizing damage to the color of the colored fabric.

14. An article according to claim 13, wherein said bleach composition is a liquid bleach composition.

15. An article according to claim 13, wherein said colored fabric comprises dark and/or black colored fabric.

16. An article of manufacture according to claim 15, wherein said dark colored fabric items herein are colored by a single dark color, or are colored by a pattern or design composed of a multitude of dark colors or a pattern or design composed of a mixture of at least one dark color and at least one light color, wherein said dark color or dark colors constitute at least about 50% of the total surface area of said pattern or design.

17. An article of manufacture according to claim 15, wherein said dark colored fabric items are colored by a color having a luminosity dimension L* of from about 35 to about 0.

18. An article of manufacture according to claim 15, wherein said dark colored fabric items are black or have a pattern or design composed of a mixture of black and other colors, wherein at least about 50% of the total surface area of said pattern or design is black.

19. An article of manufacture according to claim 15, wherein said article of manufacture in addition to the usage instructions bears an additional indication comprising a term selected from the group consisting of: noir, black, bleach for blacks, bleach noir, dark bleach, bleach for darks, bleach dark colors, bleach for black colors, for black fabrics, for dark fabrics, negro, nero, preto, schwarz, dark, oscuro, escuro, scuro and combinations thereof.

20. An article according to claim 13, wherein said liquid bleach composition comprises about 30% or less of peroxygen bleach selected from the group consisting of: hydrogen peroxide; water soluble sources of hydrogen peroxide; organic or inorganic peracids; hydroperoxides; and diacyl peroxides; and mixtures thereof, and optionally from 0% to about 30% of dye maintenance agent being cyclic amine based polymer, oligomer or copolymer, and wherein said bleaching composition as is has a pH, measured at 25° C., of no more than about 9.

21. An article according to claim 14, wherein the set of instructions comprises an instruction to apply an effective amount of liquid bleach composition in its neat or diluted form to fabric.

22. An article according to claim 13, wherein said peroxygen bleach is selected from the group consisting of: hydrogen peroxide; water soluble sources of hydrogen peroxide; organic or inorganic peracids; hydroperoxides; and diacyl peroxides; and mixtures thereof.

23. An article according to claim 13, wherein said composition comprises a dye maintenance agent comprising a cyclic amine based polymer, oligomer or copolymer.

24. An article according to claim 23, wherein said dye maintenance agent is a cyclic amine based polymer, oligomer or copolymer of the general formula: 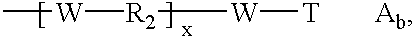
wherein each T is independently selected from the group consisting of: H, C₁-C₁₂ alkyl, substituted alkyl, C₇-C₁₂ alkylaryl,
—(CH₂)ₕCOOM, —(CH₂)ₕSO₃M, CH₂CH(OH)SO₃M, —(CH₂)ₕOSO₃M, 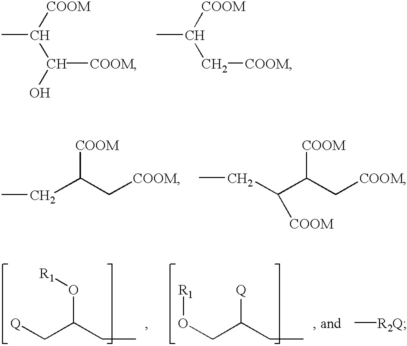
wherein W comprises at least one cyclic constituent selected from the group consisting of: 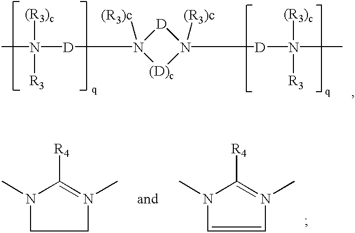
in addition to the at least one cyclic constituent, W may also comprise an aliphatic or substituted aliphatic moiety of the general structure; 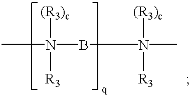
each B is independently C₁-C₁₂ alkylene, C₁-C₁₂ substituted alkylene, C₃-C₁₂ alkenylene, C₈-C₁₂ dialkylarylene, C₈-C₁₂ dialkylarylenediyl, and —(R₅O)ₙR₅—;
each D is independently C₂-C₆ alkylene;
each Q is independently selected from the group consisting of hydroxy, C₁-C₁₈ alkoxy, C₂-C₁₈ hydroxy alkoxy, amino, C₁-C₁₈ alkyl amino, dialkyl amino, trialkyl amino groups, heterocyclic monoamino groups and diamine groups;
each R₁ is independently selected from the group consisting of H, C₁-C₈ alkyl and C₁-C₈ hydroxyalkyl;
each R₂ is independently selected from the group consisting of: C₁-C₁₂ alkylene, C₁-C₁₂ alkenylene, —CH₂—CH(OR₁)—CH₂, C₈-C₁₂ alkarylene, C₄-C₁₂ dihydroxy alkylene, poly(C₂-C₄ alkyleneoxy) alkylene, H₂CH(OH)CH₂OR₂OCH₂CH(OH)CH₂—, and C₃-C₁₂ hydrocarbyl moieties;
provided that when R₂ is a C₃-C₁₂ hydrocarbyl moiety the hydrocarbyl moiety can comprise from about 2 to about 4 branching moieties of the general structure: 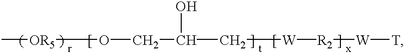
each R₃ is independently selected from the group consisting of: H, R₂, O, C₁-C₂₀ hydroxyalkyl, C₁-C₂₀ alkyl, substituted alkyl, C₆-C₁₁ aryl, substituted aryl, C₇-C₁₁ alkylaryl, C₁-C₂₀ aminoalkyl,
—(CH₂)ₕCOOM, —(CH₂)ₕSO₃M, CH₂CH(OH)SO₃M, —(CH₂)ₕOSO₃M, 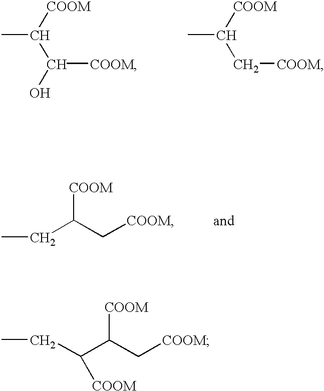
wherein at least 10 mole % of the R₃ groups are O, provided that O is only present on a tertiary N;
each R₄ is independently selected from the group consisting of: H, C₁-C₂₂ alkyl, C₁-C₂₂ hydroxyalkyl, aryl and C₇-C₂₂ alkylaryl;
each R₅ is independently selected from the group consisting of: C₂-C₈ alkylene, C₂-C₈ alkyl substituted alkylene; and
A is a compatible monovalent or di or polyvalent anion;
M is a compatible cation;
and wherein b=number necessary to balance the charge; each x is independently from 3 to 1000; each c is independently 0 or 1; each h is independently from 1 to 8; each q is independently from 0 to 6; each n is independently from 1 to 20; each r is independently from 0 to 20; and each t is independently from 0 to 1.

25. An article according to claim 24, wherein each R₁ is H and at least one W is seleted from the group consisting of:

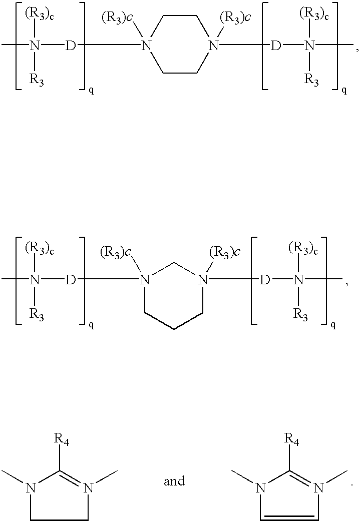

26. An article according to claim 25, wherein R₁ is H and at least one W is selected from the group consisting of:

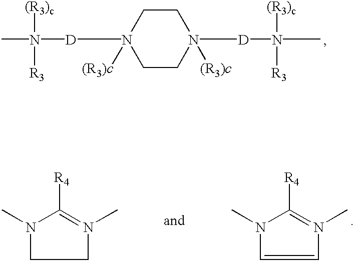

27. An article according to claim 26, wherein each R₁ is H and at least one W is selected from the group consisting of:

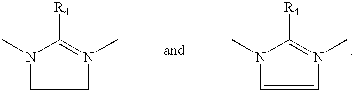

28. An article according to claim 27, wherein said cyclic amine based polymers, oligomers or copolymers are oxidized adducts selected from the group consisting of piperazine, piperidine, epichlorohydrin, epichlorohydrin benzyl quat, epichlorohydrin methyl quat, morpholine and mixtures thereof.

29. An article according to claim 14, wherein the set of instructions comprises an instruction to direct the consumer to use said liquid bleach composition in diluted condition at a level to provide from about 1 to about 15 grams of peroxygen bleach per kilogram of dry fabric.

30. An article according to claim 14, wherein the set of instructions comprises an instruction to direct the consumer to use said liquid bleach composition in neat condition at a level to provide from about 25 to about 100 grams of peroxygen bleach composition per kilogram of dry fabric.

31. An article according to claim 13, wherein the set of instructions comprises words, pictures, icons or multi-lingual instructions.

32. An article according to claim 13, wherein the set of instructions is provided via electronic and/or print media.

33. An article according to claim 13, wherein said set of instructions is posted on a global computer network at an address associated with the bleach composition and/or fabric.

34. A method according to claim 13, wherein the set of instructions is posted at the point of sale adjacent the package.

35. A method for bleaching and/or removing stain from a colored fabric, said method comprising the steps of:
providing an article of manufacture according to claim 13; and
contacting the colored fabric with the solid or liquid bleach composition of the article of manufacture according to the set of instructions associated with the package of the article of manufacture.

36. A method for teaching a consumer to bleach and/or remove stain from a colored fabric, said method comprising the steps of:
providing an article of manufacture according to claim 13; and
educating the consumer to bleach and/or remove stain from a colored fabric upon the consumer reading the set of instructions associated with the package of the article of manufacture.

37. A method of promoting the use of solid or liquid bleach composition comprising peroxygen bleach and optionally a color protection agent comprising dye maintenance agent and/or color safety ingredient to safely bleach and/or remove stain from a colored fabric comprising dark and/or black colored fabric, the method comprising the step of informing a consumer that the treatment of dark and/or black colored fabric with said composition prevents damage or reduce damage to the color of said fabric.

38. A method according to claim 37, wherein the step of informing the consumer is provided via electronic and/or print media.

39. A method of promoting the use of solid or liquid bleach composition comprising peroxygen bleach and optionally a color protection agent comprising dye maintenance agent and/or color safety ingredient to bleach and/or remove stain from colored fabric comprising dark and/or black colored fabric, the method comprising the step of informing a consumer that the color protection agent will reduce and/or prevent the damage to the color of said fabric.

40. A method according to claim 39, wherein the step of informing the consumer is provided via electronic and/or print media.
